(19) United States
(12) Patent Application Publication
(10) Pub. No.: US 2026/0002003 A1
(43) Pub. Date: Jan. 1, 2026

(54) AMORPHOUS POLYESTER RESIN, POLYESTER WATER DISPERSION, METHOD OF MANUFACTURING POLYESTER WATER DISPERSION, RESIN PARTICLES, METHOD OF MANUFACTURING RESIN PARTICLES, TONER RESIN PARTICLES, TONER, DEVELOPER, TONER STORAGE UNIT, AND IMAGE FORMING APPARATUS

(71) Applicants: Junichi Watanabe, Kanagawa (JP); Akinori Saitoh, Kanagawa (JP); Masahiro Yukikawa, Kanagawa (JP)

(72) Inventors: Junichi Watanabe, Kanagawa (JP); Akinori Saitoh, Kanagawa (JP); Masahiro Yukikawa, Kanagawa (JP)

(73) Assignee: Ricoh Company, Ltd., Tokyo (JP)

(21) Appl. No.: 19/245,695

(22) Filed: Jun. 23, 2025

(30) Foreign Application Priority Data
Jun. 27, 2024 (JP) 2024-103544

(51) Int. Cl. C08J 3/05; C08J 3/09; G03G 9/093

(52) U.S. Cl. CPC C08J 3/05; C08J 3/09; G03G 9/09328; G03G 9/09371; C08J 2367/02

(57) ABSTRACT

An amorphous polyester resin is provided that includes a polycondensation product of an alcohol component and a carboxylic acid component. The alcohol component includes at least one selected from the group consisting of plant-derived 1,3-propanediol, plant-derived 1,3-butanediol, and plant-derived ethylene glycol, and the carboxylic acid component includes a polycarboxylic acid having a sulfo group. A ratio (OHVa/AVa) of a hydroxyl value (OHVa) of the amorphous polyester resin with respect to an acid value (AVa) of the amorphous polyester resin is from 1.1 to 1.5.

### CROSS-REFERENCE TO RELATED APPLICATIONS

This patent application is based on and claims priority pursuant to 35 U.S.C. § 119(a) to Japanese Patent Application No. 2024-103544, filed on Jun. 27, 2024, in the Japan Patent Office, the entire disclosure of which is hereby incorporated by reference herein.

### BACKGROUND

### Technical Field

The present disclosure relates to an amorphous polyester resin, a polyester water dispersion, a method of manufacturing a polyester water dispersion, resin particles, a method of manufacturing resin particles, toner resin particles, a toner, a developer, a toner storage unit, and an image forming apparatus.

### Related Art

Conventionally, resin materials such as binder resins of toners are mostly dependent on petroleum resources, and the carbon dioxide generated when these materials are disposed of is released into the atmosphere, which is believed to contribute to global warming. Further, the shift from petroleum-derived resins, which have limited resources, to biomass resins and recycled resins, which are environmentally friendly, can be seen as a shift to sustainable, renewable, environmentally friendly materials, and thus, technology related thereto is in high demand.

Therefore, as binder resins for toner, environmentally friendly resins are considered, for example, polyester, polylactic acid (PLA), rosin compounds, and recycled polyethylene terephthalate (PET), in which the monomer is propylene glycol, a plant-derived renewable resource.

### SUMMARY

Embodiments of the present invention provides an amorphous polyester that includes a polycondensation product of an alcohol component and a carboxylic acid component. The alcohol component includes at least one selected from the group consisting of plant-derived 1,3-propanediol, plant-derived 1,3-butanediol, and plant-derived ethylene glycol, and the carboxylic acid component includes a polycarboxylic acid having a sulfo group. A ratio (OHVa/AVa) of a hydroxyl value (OHVa) of the amorphous polyester resin with respect to an acid value (AVa) of the amorphous polyester resin is from 1.1 to 1.5.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a general configuration diagram illustrating an image forming apparatus; and

FIG. 2 is a general configuration diagram illustrating a process cartridge as a toner storage unit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

According to embodiments of the present invention, an amorphous polyester resin is provided which has excellent environmental compatibility, excellent shell-forming adhesion efficiency when used as a shell for resin particles, and excellent uniformity in charging characteristics.

### Amorphous Polyester Resin A

An amorphous polyester resin A of the present disclosure is an amorphous polyester resin which is a polycondensation product of an alcohol component and a carboxylic acid component.

The alcohol component contains one or more selected from plant-derived 1,3-propanediol, plant-derived 1,3-butanediol, and plant-derived ethylene glycol. The carboxylic acid component contains at least a polycarboxylic acid having a sulfo group. A ratio (OHVa/AVa) of a hydroxyl value (OHVa) of the amorphous polyester resin A with respect to an acid value (AVa) of the amorphous polyester resin A is from 1.1 to 1.5.

### Polyester Water Dispersion

A polyester water dispersion of the present disclosure is a polyester water dispersion in which resin particles containing the amorphous polyester resin A are dispersed in an aqueous medium.

Characteristics of the polyester water dispersion include excellent environmental compatibility, excellent shell-forming adhesion efficiency when used as a shell for resin particles, and uniform charging characteristics. Therefore, when the polyester water dispersion is used as a raw material for forming a shell material of a toner, the occurrence of background contamination can be reduced due to the uniform charging characteristics. Accordingly, the polyester water dispersion is suitable as a raw material for forming a shell material of a toner.

### Method of Manufacturing Polyester Water Dispersion

A method of manufacturing the polyester water dispersion of the present disclosure includes step a and step b described below.

Step a: A step of preparing an oil phase by dissolving or dispersing in an organic solvent the amorphous polyester resin A that is a polycondensation product of an alcohol component and a carboxylic acid component, where the alcohol component includes one or more selected from plant-derived 1,3-propanediol, plant-derived 1,3-butanediol, and plant-derived ethylene glycol, the carboxylic acid component includes at least a polycarboxylic acid having a sulfo group, and a ratio (OHVa/AVa) of the hydroxyl value (OHVa) of the amorphous polyester resin A with respect to the acid value (AVa) of the amorphous polyester resin A is from 1.1 to 1.5.

Step b: A step of adding water to the oil phase to cause phase inversion from a water-in-oil dispersion liquid to an oil-in-water dispersion liquid.

### Resin Particles

Resin particles of the present disclosure are resin particles each having a core-shell structure including a core layer and a shell layer, and the shell layer contains the amorphous polyester resin A of the present disclosure.

### Method of Manufacturing Resin Particles

A method of manufacturing the resin particles of the present disclosure includes step a, step b, step c, and step d described below.

Step a: A step of preparing an oil phase by dissolving or dispersing an amorphous polyester resin B in an organic solvent.

Step b: A step of adding water to the oil phase to cause phase inversion from a water-in-oil dispersion liquid to an oil-in-water dispersion liquid.

Step c: A step of aggregating dispersed particles in the oil-in-water dispersion liquid.

Step d: A step of forming, after step c, a shell layer by adding the polyester water dispersion of the present disclosure to aggregate the amorphous polyester resin A in the polyester water dispersion.

### Toner Resin Particles

Toner resin particles of the present disclosure contain the resin particles of the present disclosure.

### Toner

Toner of the present disclosure contains the toner resin particles of the present disclosure.

The resin particles and the toner resin particles may contain other components such as a crystalline resin, a release agent, and a colorant, if desired.

The amorphous polyester resin A, a polyester water dispersion, a method of manufacturing a polyester water dispersion, resin particles, a method of manufacturing resin particles, toner resin particles, a toner, a developer, a toner storage unit, and an image forming apparatus of the present disclosure will be described in detail below. Note that the present invention is not limited to the embodiments described below, and may be changed within the scope conceivable by a person skilled in the art, including other embodiments, additions, modifications, omissions, and the like. The obtained embodiments are included within the scope of the present disclosure, as long as the functions and effects of the present disclosure are achieved in any aspect.

First, a plant-derived resin, which is an environmentally friendly resin, will be described.

### Plant-Derived Component

A plant-derived component is not particularly limited and can be appropriately selected according to a purpose, as long as the plant-derived component is a component derived from a plant. Examples of the plant-derived component include, but are not limited to, monomers derived from plants and monomers that can be replaced with a plant-derived component. These plant-derived components may be used alone or in combination of two or more types.

In recent years, it has become possible to replace also materials that conventionally used petroleum-derived materials with plant-derived materials. Accordingly, the commercialization of plant-derived materials such as ethylene glycol, propylene glycol, 1,3-propanediol, 1,4-butanediol, neopentyl glycol, succinic acid, itaconic acid, sebacic acid, and dodecanedioic acid is already progressing.

The plant-derived monomer in the present disclosure is not particularly limited and can be appropriately selected according to a purpose. Examples thereof include, but are not limited to, ethylene glycol, 1,3-propanediol, 1,3-butanediol, neopentyl glycol, succinic acid, itaconic acid, sebacic acid, and dodecanedioic acid. These plant-derived monomers may be used alone or in combination of two or more types. The plant-derived monomer is preferably ethylene glycol, 1,3-propanediol, and 1,3-butanediol.

When an aqueous dispersion of polyester made from a plant-derived resin is used as a shell material for resin particles, the shell material may be too stable and may not adhere to the core of the shell, so that it may not be possible to coat the toner. If the shell does not adhere to the core, the electrostatic properties of the resin particles are non-uniform, which is undesired. Therefore, the shell material needs to have appropriate stability control, which led to embodiments of the present disclosure.

### Amorphous Polyester Resin

The amorphous polyester resin forming the shell layer of the core-shell structure is preferably the amorphous polyester resin A described in detail below, and the amorphous polyester resin contained in the core of the resin particles is preferably the amorphous polyester resin B described in detail below.

### Amorphous Polyester Resin A

As the amorphous polyester resin A, a linear polyester resin is preferred, and an unmodified polyester resin is also preferred. The amorphous polyester resin A is a polyester resin soluble in tetrahydrofuran (THF) and chloroform.

The unmodified polyester resin is a polyester resin obtained by using a polyhydric alcohol and a polycarboxylic acid having a sulfo group, another polycarboxylic acid, or a derivative thereof, and is a polyester resin not modified by a compound or the like. As the amorphous polyester resin A, a component derived from polyethylene terephthalate or polybutylene terephthalate, which are recycled resins, may be used. The amorphous polyester resin A preferably does not contain a urethane bond or a urea bond.

By using the environmentally friendly component in at least one of the polyhydric alcohol and the polycarboxylic acid or a derivative thereof, the amorphous polyester resin A can be obtained as an environmentally friendly component. The amorphous polyester resin A is preferably an amorphous polyester resin having a sulfo group. When the amorphous polyester resin A contains a sulfo group, the electrostatic properties of resin particles formed of the amorphous polyester resin A are improved.

### Polyhydric Alcohol

The polyhydric alcohol is not particularly limited, can be appropriately selected according to a purpose, and examples thereof include diols.

Examples of the diols include, but are not limited to, alkylene (2 to 3 carbon atoms) oxide adducts (average number of moles added: 1 to 10) of bisphenol A, ethylene glycol, 1,3-propanediol, 1,3-butanediol, hydrogenated bisphenol A, and alkylene (2 to 3 carbon atoms) oxide adducts (average number of moles added: 1 to 10) of hydrogenated bisphenol A.

Examples of the alkylene (2 to 3 carbon atoms) oxide adduct (average number of moles added: 1 to 10) of bisphenol A include, but are not limited to, polyoxypropylene (2.2)-2,2-bis(4-hydroxyphenyl)propane and polyoxyethylene (2.2)-2,2-bis(4-hydroxyphenyl)propane.

These materials may be used alone or in combination of two or more types.

Among these materials, the polyhydric alcohol more preferably contains plant-derived ethylene glycol, plant-derived 1,3-propanediol, or plant-derived 1,3-butanediol, because in this case, the environmental compatibility can be improved. Further, by using such a short-chain polyhydric alcohol, the concentration of ester groups in the amorphous polyester resin A increases, which increases the aggregation properties when the amorphous polyester resin A is prepared as an aqueous dispersion, and facilitates adhesion to the core when the amorphous polyester resin A is used as a shell.

For the purpose of adjusting the acid value and the hydroxyl value, the amorphous polyester resin A may contain a trihydric or higher alcohol at an end of its resin chain.

Examples of the trihydric or higher alcohol include, but are not limited to, glycerin, pentaerythritol, and trimethylolpropane. By using plant-derived glycerin, the environmental compatibility can be improved.

### Polycarboxylic Acid Having Sulfo Group

Examples of the polycarboxylic acid having a sulfo group include polycarboxylic acids containing a sulfo group and a salt group in their backbones that can be copolymerized into a polyester. Specific examples of the polycarboxylic acid having a sulfo group include, but are not limited to, 5-sulfoisophthalic acid, 2-sulfoisophthalic acid, 4-sulfoisophthalic acid, 4-sulfo-2,6-naphthalenedicarboxylic acid, sulfoterephthalic acid, and ammonium salts, lithium salts, sodium salts, potassium salts, magnesium salts, calcium salts, copper salts, and iron salts of these acids.

These polycarboxylic acids having a sulfo group may be used alone or in combination of two or more types. Among these examples of the polycarboxylic acids having a sulfo group, 5-sulfoisophthalate is preferred, and 5-sulfoisophthalic acid sodium salt or 5-sulfoisophthalic acid potassium salt are particularly preferred.

A molar ratio of the polycarboxylic acid having a sulfo group is not particularly limited and can be appropriately selected according to a purpose. However, the molar ratio is preferably from 2 mol % to 10 mol %, and more preferably from 2 mol % to 5 mol %, with respect to the total amount of the carboxylic acid monomers included in the polyester resin. When the molar ratio of the polycarboxylic acid having a sulfo group is 2 mol % or more, the electrostatic properties are excellent. When the molar ratio of the polycarboxylic acid having a sulfo group is 10 mol % or less, the aggregation properties of the polyester water dispersion thereof increase, and when the polyester resin is used as a shell of a resin particle, the adhesion increases.

The molar ratio of the polycarboxylic acid having a sulfo group can be measured as follows. Pyrolysis gas chromatography (pyrolysis GC) is used to obtain the area of a chromatogram derived from a monomer having a sulfo group, and the area is substituted in a calibration curve equation for the monomer having a sulfo group to calculate the molar ratio.

The content of the amorphous polyester resin A in the resin particles is not particularly limited and can be appropriately selected according to a purpose. However, the content is preferably from 5 mass % to 40 mass %, and more preferably from 10 mass % to 40 mass %, with respect to the total mass of the resin particles. When the content of the amorphous polyester resin A is 5 mass % or more, an effect on the heat-resistant storage stability can be sufficiently obtained. When the content of the amorphous polyester resin A is 40 mass % or less, sufficient fixability at low temperatures can be obtained.

The presence of the amorphous polyester resin A in the resin particles can be confirmed by, for example, a method of measuring the sulfur (S) intensity by trace element analysis using an X-ray fluorescence method, a method of quantifying monomers having sulfo groups by gas chromatography mass spectrometry (GC/MS), and a method of quantifying sulfo groups on an outermost surface of the resin particles by time-of-flight secondary ion mass spectrometry (TOF-SIMS) and qualitatively analyzing the resin structure on the outermost surface of the resin particles.

### Component Derived from Polyethylene Terephthalate or Polybutylene Terephthalate

The component derived from polyethylene terephthalate (PET) or polybutylene terephthalate (PBT) is not particularly limited and can be appropriately selected according to a purpose, as long as the component is derived from PET or PBT.

Hereinafter, “polyethylene terephthalate” may be referred to as “PET” and “polybutylene terephthalate” as “PBT”.

The PET generally comprises ethylene glycol and terephthalic acid. The PBT generally comprises butylene glycol and terephthalic acid. Therefore, examples of the component derived from PET or PBT include, but are not limited to, monomer units such as ethylene glycol, butylene glycol, and terephthalic acid.

As the PET or the PBT, it is preferable to use recycled PET or recycled PBT to ensure environmental compatibility.

The recycled PET or the recycled PBT is not particularly limited and can be appropriately selected according to a purpose. For example, recycled products of manufactured goods including PET or PBT, off-spec fiber waste, and pellets can be used. Among these products, recycled products (may be referred to as “recycled resin” hereinafter) processed into flakes are preferred.

The molecular weight distribution, the composition, the manufacturing method, and the usage form of PET and PBT used as the raw material of the component derived from PET or PBT are not particularly limited, and can be appropriately selected according to a purpose.

The weight average molecular weight (Mw) of the PET or PBT is not particularly limited and can be appropriately selected according to a purpose, but is preferably from 30,000 to 100,000.

### Polycarboxylic Acid and Derivatives Thereof

The polycarboxylic acid is not particularly limited, can be appropriately selected according to a purpose, and examples thereof include, but are not limited to, dicarboxylic acids.

Examples of the dicarboxylic acids include, but are not limited to, adipic acid, phthalic acid, isophthalic acid, terephthalic acid, fumaric acid, maleic acid, succinic acid, sebacic acid, dodecanedioic acid, and succinic acid substituted with an alkyl group having 1 to 20 carbon atoms or an alkenyl group having 2 to 20 carbon atoms.

Examples of the succinic acid substituted with an alkyl group having 1 to 20 carbon atoms or an alkenyl group having 2 to 20 carbon atoms include, but are not limited to, dodecenylsuccinic acid and octylsuccinic acid.

The derivative of the polycarboxylic acid is not particularly limited, can be appropriately selected according to a purpose, and examples thereof include, but are not limited to, polycarboxylic acid anhydrides and polycarboxylic acid esters.

These materials may be used alone or in combination of two or more types.

Among these materials, the polycarboxylic acid preferably contains, as the environmentally friendly component, succinic acid, sebacic acid, or dodecanedioic acid, which are saturated aliphatic acids derived from plants or derived from recycled PET or recycled PBT. By using a polycarboxylic acid derived from plants or derived from recycled PET or recycled PBT, the environmental compatibility can be improved.

The acid value of the amorphous polyester resin A is not particularly limited and can be appropriately selected according to a purpose, but is preferably 1 mgKOH/g or more and 50 mgKOH/g or less, and more preferably 5 mgKOH/g or more and 30 mgKOH/g or less. When the acid value of the amorphous polyester resin A is 1 mgKOH/g or more, a toner containing the resin particles is easily charged to a negative charge. Further, when the toner is fixed to a recording medium such as paper, the affinity between the recording medium and the toner is improved, and the fixability at low temperatures can be improved. When the acid value of the amorphous polyester resin A is 50 mgKOH/g or less, it is possible to prevent a decrease in charging stability, particularly in charging stability relating to environmental fluctuations.

The acid value of the amorphous polyester resin A can be measured in conformity with the measurement method described in Japanese Industrial Standards (JIS) K0070-1992.

The hydroxyl value of the amorphous polyester resin A is not particularly limited and can be appropriately selected according to a purpose, but is preferably 5 mgKOH/g or more. The upper limit value of the hydroxyl value of the amorphous polyester resin A is not particularly limited and can be appropriately selected according to a purpose, but is preferably 30 mgKOH/g or less. The lower limit value and the upper limit value of the hydroxyl value of the amorphous polyester resin A can be appropriately combined, and the obtained range is preferably from 5 mgKOH/g to 30 mgKOH/g.

The hydroxyl value of the amorphous polyester resin A can be measured in conformity with the measurement method described in JIS K0070-1966.

When the amorphous polyester resin A is used as an aqueous dispersion and the aqueous dispersion is used to form a shell material for resin particles, the ratio (OHVa/AVa) of the hydroxyl value (OHVa) of the amorphous polyester resin A with respect to the acid value (AVa) is preferably from 1.1 to 1.5. When the ratio is lower than 1.1, the shell material is too stable and does not adhere to the core. When the ratio exceeds 1.5, the aggregation properties of the shell material are too strong, and the shell aggregates alone and does not adhere to the core.

### Amorphous Polyester Resin B

The amorphous polyester resin B is preferably a linear polyester resin, and more preferably an unmodified polyester resin. The amorphous polyester resin B is a polyester resin soluble in tetrahydrofuran (THF) and chloroform.

The unmodified polyester resin is a polyester resin obtained by using a polyhydric alcohol and a polycarboxylic acid or a derivative thereof, and is a polyester resin that is not modified with an isocyanate compound or the like. A component derived from polyethylene terephthalate or polybutylene terephthalate, which are recycled resins, may be used as the amorphous polyester resin B. The amorphous polyester resin B preferably does not contain a urethane bond or a urea bond. By using the above-mentioned environmentally friendly component in at least one of the polyhydric alcohol and the polycarboxylic acid or the derivative thereof, the amorphous polyester resin B can be obtained as an environmentally friendly component.

### Polyhydric Alcohol

The polyhydric alcohol is not particularly limited, can be appropriately selected according to a purpose, and examples thereof include diols.

Examples of the diols include, but are not limited to, an alkylene (2 to 3 carbon atoms) oxide adduct (average number of moles added: 1 to 10) of bisphenol A, ethylene glycol, butylene glycol, propylene glycol, hydrogenated bisphenol A, and an alkylene (2 to 3 carbon atoms) oxide adduct (average number of moles added: 1 to 10) of hydrogenated bisphenol A.

Examples of the alkylene (carbon number 2 to 3) oxide adduct (average number of moles added: 1 to 10) of bisphenol A include, but are not limited to, polyoxypropylene (2.2)-2,2-bis(4-hydroxyphenyl)propane and polyoxyethylene (2.2)-2,2-bis(4-hydroxyphenyl)propane.

These materials may be used alone or in combination of two or more types.

Among these materials, the polyhydric alcohol more preferably contains plant-derived ethylene glycol, plant-derived 1,3-propanediol, or plant-derived 1,3-butanediol, because in this case, the environmental compatibility can be improved. Further, by using such a short-chain polyhydric alcohol, the concentration of ester groups in the amorphous polyester resin B increases, the aggregation properties increase, and adhesion to the shell is facilitated when the amorphous polyester resin B is used as a core.

For the purpose of adjusting the acid value and the hydroxyl value, the amorphous polyester resin B may contain a trihydric or higher alcohol at an end of its resin chain.

Examples of the trihydric or higher alcohol include, but are not limited to, glycerin, pentaerythritol, and trimethylolpropane.

### Polycarboxylic Acid and Derivatives Thereof

The polycarboxylic acid is not particularly limited, can be appropriately selected according to a purpose, and examples thereof include, but are not limited to, dicarboxylic acids.

Examples of the dicarboxylic acids include, but are not limited to, adipic acid, phthalic acid, isophthalic acid, terephthalic acid, fumaric acid, maleic acid, succinic acid, sebacic acid, dodecanedioic acid, and succinic acid substituted with an alkyl group having 1 to 20 carbon atoms or an alkenyl group having 2 to 20 carbon atoms.

Examples of the succinic acid substituted with an alkyl group having 1 to 20 carbon atoms or an alkenyl group having 2 to 20 carbon atoms include, but are not limited to, dodecenylsuccinic acid and octylsuccinic acid.

The derivative of the polycarboxylic acid is not particularly limited, can be appropriately selected according to a purpose, and examples thereof include, but are not limited to, polycarboxylic acid anhydrides and polycarboxylic acid esters.

These materials may be used alone or in combination of two or more types.

Among these materials, the polycarboxylic acid preferably contains, as the environmentally friendly component, succinic acid, sebacic acid, and dodecanedioic acid, which are saturated aliphatic acids derived from plants. When the polycarboxylic acid is derived from a plant, the environmental compatibility can be improved.

The amorphous polyester resin B preferably contains a dicarboxylic acid component as a constituent component, and the dicarboxylic acid component preferably contains 50 mol % or more of terephthalic acid. This is advantageous to obtain heat-resistant storage stability.

For the purpose of adjusting the acid value and the hydroxyl value, the amorphous polyester resin B may contain a trivalent or higher carboxylic acid at an end of its resin chain.

Examples of the trivalent or higher carboxylic acid include, but are not limited to, trimellitic acid, pyromellitic acid, and acid anhydrides thereof.

### Component Derived from Polyethylene Terephthalate or Polybutylene Terephthalate

The component derived from polyethylene terephthalate (PET) or polybutylene terephthalate (PBT) is not particularly limited and can be appropriately selected according to a purpose, as long as the component is derived from PET or PBT.

The PET generally comprises ethylene glycol and terephthalic acid. The PBT generally comprises butylene glycol and terephthalic acid. Therefore, examples of the component derived from PET or PBT include, but are not limited to, monomer units such as ethylene glycol, butylene glycol, and terephthalic acid.

As the PET or the PBT, it is preferable to use recycled PET or recycled PBT to ensure environmental compatibility.

The recycled PET or the recycled PBT is not particularly limited and can be appropriately selected according to a purpose. For example, recycled products of manufactured goods including PET or PBT, off-spec fiber waste, and pellets can be used. Among these products, recycled products (may be referred to as “recycled resin” hereinafter) processed into flakes are preferred.

The molecular weight distribution, the composition, the manufacturing method, and the usage form of PET or PBT used as the raw material of the component derived from PET or PBT are not particularly limited, and can be appropriately selected according to a purpose.

The weight average molecular weight (Mw) of the PET or PBT is not particularly limited and can be appropriately selected according to a purpose, but is preferably from 30,000 to 100,000.

The molecular weight of the amorphous polyester resin B is not particularly limited and can be appropriately selected according to a purpose. However, the molecular weight measured by GPC is preferably in the ranges mentioned below.

The weight average molecular weight (Mw) of the amorphous polyester resin B is preferably from 3,000 to 10,000, and more preferably from 4,000 to 10,000.

The number average molecular weight (Mn) of the amorphous polyester resin B is preferably from 1,000 to 4,000, and more preferably from 1,500 to 3,000.

The molecular weight ratio (Mw/Mn) of the amorphous polyester resin B is preferably from 1.0 to 4.0, and more preferably from 1.0 to 3.5.

When the weight average molecular weight (Mw) and the number average molecular weight (Mn) of the amorphous polyester resin B are equal to or greater than the lower limit value of the above-mentioned preferred range, a decrease in the heat-resistant storage stability of the resin particles and in the durability against stress such as stirring in a developing device can be prevented. When the weight average molecular weight (Mw) and the number average molecular weight (Mn) of the amorphous polyester resin B are equal to or less than the upper limit value of the above-mentioned preferred range, an increase in the viscoelasticity of the resin particles when the resin particles are melted and a decrease in the fixability at low temperatures can be prevented.

The acid value of the amorphous polyester resin B is not particularly limited and can be appropriately selected according to a purpose, but is preferably from 1 mgKOH/g to 50 mgKOH/g, and more preferably from 5 mgKOH/g to 30 mgKOH/g. When the acid value of the amorphous polyester resin B is 1 mgKOH/g or more, a toner containing the resin particles is easily charged to a negative charge. Further, when the toner is fixed to a recording medium such as paper, the affinity between the recording medium and the toner is improved, and the fixability at low temperatures can be improved. When the acid value of the amorphous polyester resin B is 50 mgKOH/g or less, a decrease in charging stability, particularly in charging stability relating to environmental fluctuations, can be prevented.

The acid value of the amorphous polyester resin B can be measured in conformity with the measurement method described in JIS K0070-1992.

The hydroxyl value of the amorphous polyester resin B is not particularly limited and can be appropriately selected according to a purpose, but is preferably 5 mgKOH/g or more. The upper limit value of the hydroxyl value of the amorphous polyester resin B is not particularly limited and can be appropriately selected according to a purpose, but is preferably 30 mgKOH/g or less. The lower limit value and the upper limit value of the hydroxyl value of the amorphous polyester resin B can be appropriately combined, and the obtained range is preferably from 5 mgKOH/g to 30 mgKOH/g.

The hydroxyl value of the amorphous polyester resin B can be measured in conformity with the measurement method described in JIS K0070-1966.

When the amorphous polyester resin B is used as a core of resin particles, the ratio (OHVa/AVa) of the hydroxyl value (OHVa) of the amorphous polyester resin B with respect to the acid value (AVa) is preferably from 1.1 to 1.5. When the ratio is lower than 1.1, the material is too stable and repels the shell, so that the shell does not adhere to the core. When the ratio exceeds 1.5, the aggregation properties of the shell material are too strong, and cores aggregate with each other to form coarse particles.

The glass transition temperature (Tg) of the amorphous polyester resin B is not particularly limited and can be appropriately selected according to a purpose, but is preferably 40° C. or higher and 80° C. or lower, and more preferably 50° C. or higher and 70° C. or lower.

When the glass transition temperature (Tg) of the amorphous polyester resin B is 40° C. or higher, a toner containing the resin particles has sufficient heat-resistant storage stability and durability against stress such as stirring in a developing device, and also has good filming resistance. When the glass transition temperature (Tg) of the amorphous polyester resin B is 80° C. or lower, the toner containing the resin particles is sufficiently deformed by heat and pressure during fixing, and thus, good fixability at low temperatures is obtained.

The molecular structure of the amorphous polyester resin B can be confirmed by a measurement using nuclear magnetic resonance spectroscopy (NMR) of a solution or a solid, and further, by a measurement method using X-ray diffraction, gas chromatography/mass spectrometry (GC/MS), liquid chromatographic/mass spectrometry (LC/MS), and infrared absorption spectroscopy (IR). Among these measurement methods, an example of a method includes, but is not limited to, a method of detecting, as the amorphous polyester resin B, a resin that does not absorb at 965±10 cm⁻¹ and 990±10 cm⁻¹ from δCH (out-of-plane bending vibration) of an olefin in an infrared absorption spectrum obtained by IR.

The content of the amorphous polyester resin B is not particularly limited and can be appropriately selected according to a purpose. However, the content is preferably 50 parts by mass or more and 90 parts by mass or less, and more preferably 60 parts by mass or more and 80 parts by mass or less, with respect to 100 parts by mass of the resin particles. When the content of the Amorphous polyester resin B is 50 parts by mass or more with respect to 100 parts by mass of the resin particles, a deterioration in the dispersibility of pigments and release agents in the resin particles can be prevented, and the occurrence of fogging and distortion of the image can be prevented. When the content of the amorphous polyester resin B is 90 parts by mass or less with respect to 100 parts by mass of the resin particles, a decrease in the fixability at low temperatures can be prevented. When the content of the amorphous polyester resin B is within the above-mentioned more preferred range, it is advantageous in that both high image quality and excellent fixability at low temperatures can be obtained.

### Core-Shell Structure

The resin particles preferably have a core-shell structure. A shell resin contained in the shell layer is preferably the amorphous polyester resin A, and an amorphous polyester contained in the core is preferably the amorphous polyester resin B.

As used herein, “having a core-shell structure” means a structure including a core layer and a shell layer, the “shell layer” refers to a layer comprising a resin present in an outermost layer of the resin particles, and the “core layer” refers to a region within the resin particles excluding the shell layer.

The core layer and the shell layer are not completely compatible with each other and are formed inhomogeneously.

In the core-shell structure, a surface of the core layer is preferably covered with the shell layer.

In the core-shell structure, the surface of the core layer may be completely covered by the shell layer, or may not be completely covered by the shell layer. Examples of a mode in which the surface of the core layer is not completely covered with the shell layer include a mode in which the core layer is covered with the shell layer in a mesh-like pattern, and a mode in which the core layer is partially exposed from the shell layer. Among these structures, from the viewpoint of filming resistance, it is preferable that the surface of the core layer is completely covered with the shell layer.

### Shell Material

The amorphous polyester resin A is used as a shell material. As described above, the amorphous polyester resin A may be a polycondensation product of a polyhydric alcohol and a polycarboxylic acid, and contains an environmentally friendly component. The shell resin is preferably a resin containing the above-mentioned plant-derived resin.

The volume average particle diameter of the amorphous polyester in the polyester water dispersion can be measured by using a NANOTRACK particle size distribution measurement device (UPA-EX150, Nikkiso Co., Ltd., dynamic light scattering method/laser Doppler method).

First, a background measurement is performed in advance using only a dispersion solvent of a dispersion liquid of each target sample. Next, the dispersion liquids in which each target sample is dispersed are adjusted to a measurement concentration range and measured, and thus, the volume average particle diameter is measured.

A method of confirming a compositional configuration of the shell layer is not particularly limited and can be appropriately selected according to a purpose. Examples of the method include a method of confirming the compositional configuration of the shell layer by a surface layer (shell layer) composition analysis using nano IR (also referred to as “AMF-IR”).

The compositional configuration can be obtained by acquiring an IR spectrum of the surface layer (shell layer) of the resin particles by using an analytical technique that combines a nano-IR atomic force microscope (AFM) and IR to achieve nanoscale resolution.

Specifically, the resin particles are embedded in an epoxy resin (S-31, manufactured by DEVCON) and hardened. Subsequently, the epoxy resin is cut into sections with a knife. The sections are cut to a thickness of 60 nm by using an ultrasonic ultramicrotome (LEICA EM UC7, manufactured by Leica), to prepare very thin slices of the resin particles. The prepared ultrathin slices of the toner are collected on a substrate (ZnS), and a measurement location (shell layer) is measured by AFM-IR using a nanoscale infrared spectroscopic analysis system (for example, NANO IR2, manufactured by Anasys Instruments). The measurement range is from 1,900 cm⁻¹ to 910 cm⁻¹, and the resolution is 2 cm⁻¹. From the obtained AFM-IR absorption spectrum, a chemical structure of the measurement location (shell layer) can be analyzed. Therefore, the compositional configuration of the surface layer (shell layer) can be confirmed by the above-described analysis.

If the core layer is used as the measurement location, the chemical structure of the core layer can also be analyzed.

The average thickness of the shell layer is not particularly limited and can be appropriately selected according to a purpose, but is preferably from 50 nm to 500 nm, and more preferably from 100 nm to 200 nm.

When the average thickness of the shell layer is 50 nm or more, a core layer within the resin particles can be protected and the mechanical strength can be improved. When the average thickness of the shell layer is 200 nm or less, sufficient mechanical strength can be maintained, without impairing the fixability at low temperatures.

As used herein, the “average thickness of the shell layer” refers to a thickness obtained as follows. First, 50 resin particles are randomly selected from resin particles having a particle diameter within ±2.0 μm of the weight average particle diameter of the resin particles. The thickness of the shell layer of each of the 50 resin particles is measured by using a method described below, and then, an average of the thickness of the shell layer of the 50 resin particles is calculated.

The coverage rate of the surface of the core layer by the shell layer is not particularly limited and can be appropriately selected according to a purpose, but is preferably from 50% to 100%, and more preferably from 80% to 100%. When the coverage rate is 100%, the entire surface of the core layer in the resin particles is covered by the shell layer.

The coverage rate (%) of the surface of the core layer by the shell layer can be calculated by Equation (3) below.

Coverage rate (%)=(area of covered region)/(total surface area of resin particle)*100 Equation (3)

In Equation (3), the “total surface area of resin particle” refers to the sum of the area of a covered region and an exposed area of the core layer. The “area of the covered region” refers to the area of a region where the core layer is covered by the shell layer among the total surface area of the resin particle. The “exposed area of the core layer” refers to the area of a region where the core layer is not covered with the shell layer among the total surface area of the resin particle.

A method of confirming the existence of the core-shell structure in the resin particles is not particularly limited and can be appropriately selected according to a purpose. For example, the resin particles are embedded in an epoxy resin (S-31, manufactured by DEVCON) and hardened. Subsequently, the epoxy resin is cut into sections with a knife. The sections are cut to a thickness of 60 nm by using an ultrasonic ultramicrotome (LEICA EM UC7, manufactured by Leica) to prepare very thin slices of the resin particles. The prepared, very thin sections of the toner are exposed to ruthenium tetroxide (RuO₄) gas, and the shell and the core are dyed to distinguish the shell and the core. The time of the gas exposure can be appropriately adjusted depending on the contrast during observation. Afterwards, a cross-sectional image of the resin particles is observed at an acceleration voltage of 120 kV by using a transmission electron microscope (H-7500, manufactured by Hitachi High-Technologies Corporation), to confirm the existence of the core-shell structure in the resin particles.

In the TEM image observed by the above-described method, a covered region of the core layer on the surface of the resin particles (a region in the resin particles where the core layer is covered with the shell layer) and an exposed region of the core layer (a region in the resin particles where the core layer is not covered with the shell layer) can be distinguished by a difference in brightness values. Therefore, the TEM image observed by the above-described method is processed in a binarization utilizing image processing software, and by the obtained contrast ratio, the shell layer can be identified and the thickness of the shell layer can be measured.

As the image processing software, IMAGE-J can be used. A method of calculating the average thickness of the shell layer by using IMAGE-J is described below.

(1) Straight Line is used to draw straight lines following a scale. The actual length and the unit of the scale is set by using Set Scale in Analyze.

(2) The outer periphery of one resin particle in the cross-sectional image of the resin particle is surrounded by Freehand-sections to create “Region 1”.

(3) The outer periphery of a region excluding the shell layer in the cross-sectional image of the one resin particle (that is, a boundary between the shell layer and the core layer) is surrounded by Freehand-sections to create “Region 2”.

(4) The weight center of the above-mentioned “Region 1” is determined by Analyze.

(5) An originally developed plug-in is used to draw a straight line from the outer periphery of “Region 1”, that is, from coordinates obtained by dividing the line obtained by surrounding the outer periphery of the one resin particle in (2) by Freehand-sections into 100 equal parts, toward the weight center of the resin particle determined in (4) above.

(6) In each of the 100 straight lines created in (5) above, the straight lines following the scale created in (1) are utilized to calculate a length obtained by subtracting the length passing through “Region 2” from the length passing through “Region 1”. Subsequently, the average of the 100 lengths is calculated and used as the thickness of the shell layer of the one resin particle.

(7) The above-described operations (2) to (6) are performed for 50 resin particles, and an average value of the thickness of the shell layer of the 50 resin particles is calculated. The average value is defined as the average thickness of the shell layer in the present disclosure.

A method of calculating the coverage rate by the shell layer by using IMAGE-J is described below.

(1) In the cross-sectional image of one resin particle, a portion of the outer periphery of the resin particle that is covered with the shell layer is traced by using Freehand Line, and the length of the traced line is measured by Analyze. This length is defined as “Length 1”.

(2) In the cross-sectional image of the one resin particle, the outer periphery of the resin particle is traced by using Freehand Line, and the length of the traced line is measured by Analyze. This length is defined as “Length 2”.

(3) The calculation Length 1/Length 2*100 is performed, and the result is defined as the coverage rate of the one resin particle by the shell layer.

(4) The above-described operations (1) to (3) are performed for 50 resin particles, and an average value of the coverage rate of the 50 resin particles by the shell layer is calculated. The average value is defined as the coverage rate by the shell layer in the present disclosure.

### Other Components

The other components in the resin particles are not particularly limited and can be appropriately selected according to a purpose. Examples of the other components include, but are not limited to, a crystalline resin, a colorant, a release agent, a charge control agent, a fluidity improver, a cleanability improver, a magnetic material, and a deforming agent. These other components may be used alone or in combination of two or more types.

### Crystalline Resin

The crystalline resin is not particularly limited and can be appropriately selected according to a purpose, as long as the resin has crystallinity. Examples of the crystalline resin include, but are not limited to, polyester resins, polyurethane resins, polyurea resins, polyamide resins, polyether resins, vinyl resins, and modified crystalline resins. These resins may be used alone or in combination of two or more types. Among these resins, the crystalline resin is preferably a crystalline polyester resin.

### Crystalline Polyester Resin

The crystalline polyester resin (may be referred to as “crystalline polyester resin C” hereinafter) has a high crystallinity and therefore exhibits heat melting properties including a rapid change in viscosity near a fixing start temperature. The crystalline polyester resin C is a polyester resin that is insoluble in tetrahydrofuran (THF), but soluble in chloroform.

By using the crystalline polyester resin C having the above-described characteristics together with the amorphous polyester resin, it is possible to obtain resin particles having both good heat-resistant storage stability and fixability at low temperatures. For example, when the crystalline polyester resin C and the amorphous polyester resin are used together, good heat-resistant storage stability is obtained by the crystallinity of the crystalline polyester resin C until a temperature immediately before the melting start temperature. At the melting start temperature, the melting of the crystalline polyester resin C causes a sudden decrease in viscosity (sharp melting properties). As a result, the crystalline polyester resin C becomes compatible with the amorphous polyester resin, and both rapidly decrease in viscosity, which leads to good fixation. Further, the values of a release width (a difference between the lower limit fixing temperature and the temperature at which high-temperature offset occurs) also indicate good results.

The crystalline polyester resin C is obtained by using a polyhydric alcohol and a polycarboxylic acid or a derivative thereof. By using the above-described plant-derived component or the component derived from recycled PET or recycled PBT in at least one of the polyhydric alcohol and the polycarboxylic acid or the derivative thereof, the crystalline resin that can be obtained is an environmentally friendly component.

These components may be used alone or in combination of two or more types.

The derivative of the polycarboxylic acid is not particularly limited, can be appropriately selected according to a purpose, and examples thereof include, but are not limited to, a polycarboxylic acid anhydride and a polycarboxylic acid ester.

As used herein, the crystalline polyester resin C refers to a resin obtained by using, as described above, the polyhydric alcohol and the polycarboxylic acid or a derivative thereof. The crystalline polyester resin C does not refer to resins obtained by modifying a polyester resin, such as a prepolymer and a resin obtained by subjecting the prepolymer to at least one of a cross-linking reaction and an elongation reaction.

### Polyhydric Alcohol

The polyhydric alcohol is not particularly limited and can be appropriately selected according to a purpose. Examples of the polyhydric alcohol include, but are not limited to, diols and trihydric or higher alcohols.

Examples of the diols include, but are not limited to, saturated aliphatic diols.

Examples of the saturated aliphatic diols include, but are not limited to, linear saturated aliphatic diols and branched saturated aliphatic diols. Among these diols, the saturated aliphatic diol is preferably a linear saturated aliphatic diol, and more preferably a linear saturated aliphatic diol having 2 to 12 carbon atoms. The saturated aliphatic diol is preferably a linear saturated aliphatic diol, because in this case, the crystalline polyester resin C has high crystallinity and a high melting point. When the number of carbon atoms in the saturated aliphatic diol exceeds 12, it is difficult to acquire a material suitable for practical use. The saturated aliphatic diol more preferably has 12 or less carbon atoms.

Specific examples of the saturated aliphatic diol include, but are not limited to, ethylene glycol, butylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosane decanediol. These diols may be used alone or in combination of two or more types. Among these saturated aliphatic diols, ethylene glycol, butylene glycol, 1,4-butanediol, 1,6-hexanediol, 1,8-octanediol, 1,10-decanediol, and 1,12-dodecanediol are preferred to obtain high crystallinity and excellent sharp melting properties in the crystalline polyester resin C.

Examples of the trihydric or higher alcohol include, but are not limited to, glycerin, trimethylolethane, trimethylolpropane, and pentaerythritol.

These polyhydric alcohols may be used alone or in combination of two or more types.

### Polycarboxylic Acid

The polycarboxylic acid is not particularly limited, can be appropriately selected according to a purpose, and example thereof include, but are not limited to, dicarboxylic acids.

Examples of the dicarboxylic acids include, but are not limited to, saturated aliphatic dicarboxylic acids, unsaturated aliphatic dicarboxylic acids, and aromatic dicarboxylic acids.

Examples of the saturated aliphatic dicarboxylic acids include, but are not limited to, oxalic acid, malonic acid, succinic acid, glutaric acid, sebacic acid, adipic acid, and dodecanedioic acid.

Examples of the unsaturated aliphatic dicarboxylic acids include, but are not limited to, fumaric acid and maleic acid.

Examples of the saturated aliphatic dicarboxylic acid include, but are not limited to, terephthalic acid.

These dicarboxylic acids may be used alone or in combination of two or more types.

The dicarboxylic acid is preferably a saturated aliphatic dicarboxylic acid that has 4 to 12 carbon atoms and is derived from a plant. When the dicarboxylic acid is derived from a plant, the carbon neutrality can be improved. When the dicarboxylic acid has not more than 12 carbon atoms, the compatibility with the amorphous polyester resin is improved, and the fixability at low temperatures is improved.

The melting point of the crystalline polyester resin C is not particularly limited and can be appropriately selected according to a purpose, but is preferably 60° C. or higher and 80° C. or lower. When the melting point of the crystalline polyester resin C is 60° C. or higher, the crystalline polyester resin C can be prevented from melting at a low temperature, and thus, a decrease of the heat-resistant storage stability of the resin particles can be prevented. When the melting point of the crystalline polyester resin C is 80° C. or lower, the melting properties when the crystalline polyester resin C is heated during fixing can be improved, and a decrease in the fixability at low temperatures can be prevented.

The molecular weight of the crystalline polyester resin C is not particularly limited and can be appropriately selected according to a purpose. However, considering that a resin having a narrow molecular weight distribution and a low molecular weight has excellent fixability at low temperatures, and a resin having a large amount of components having high molecular weight has improved heat-resistant storage stability, it is preferable that the molecular weight of the crystalline polyester resin C measured by GPC for a portion soluble in orthodichlorobenzene is in the range below.

The weight average molecular weight (Mw) of the crystalline polyester resin C is preferably from 3,000 to 30,000, and more preferably from 5,000 to 25,000.

The number average molecular weight (Mn) of the crystalline polyester resin C is preferably from 1,000 to 10,000, and more preferably from 2,000 to 10,000.

The molecular weight ratio (Mw/Mn) of the crystalline polyester resin C is preferably from 1.0 to 10, and more preferably from 1.0 to 5.0.

The acid value of the crystalline polyester resin C is not particularly limited and can be appropriately selected according to a purpose. However, from the viewpoint of affinity between a recording medium and the resin particles, the lower limit value of the acid value is preferably 5 mgKOH/g or more, and more preferably 10 mgKOH/g or more, to achieve the desired fixability at low temperatures. The upper limit value of the acid value of the crystalline polyester resin C is preferably 45 mgKOH/g or less, to improve the high-temperature offset resistance.

The acid value of the crystalline polyester resin C can be measured in conformity with the measurement method described in JIS K0070-1992.

The hydroxyl value of the crystalline polyester resin C is not particularly limited and can be appropriately selected according to a purpose. However, to achieve the desired fixability at low temperatures and good charging characteristics, the hydroxyl value is preferably 0 mgKOH/g or more and 50 mgKOH/g or less, and more preferably 0 mgKOH/g or more and 10 mgKOH/g or less.

The hydroxyl value of the crystalline polyester resin C can be measured in conformity with the measurement method described in JIS K0070-1966.

The molecular structure of the crystalline polyester resin C can be confirmed by a measurement using nuclear magnetic resonance spectroscopy (NMR) of a solution or a solid, and further, by a measurement method using X-ray diffraction, gas chromatography/mass spectrometry (GC/MS), liquid chromatographic analysis (LC/MS), and infrared absorption spectroscopy (IR). Among these measurement methods, an example of a simple method includes a method of detecting, as the crystalline polyester resin C, a resin that absorbs at 965±10 cm⁻¹ and 990±10 cm⁻¹ from 8CH (out-of-plane bending vibration) of an olefin in an infrared absorption spectrum obtained by IR.

The content of the crystalline polyester resin C in the resin particles is not particularly limited and can be appropriately selected according to a purpose. However, the content is preferably 3 parts by mass or more and 20 parts by mass or less, and more preferably 5 parts by mass or more and 15 parts by mass or less, with respect to 100 parts by mass of the resin particles. When the content of the crystalline polyester resin C in the resin particles is 3 parts by mass or more, the sharp melting properties can be improved by the crystalline polyester resin C, and the fixability at low temperatures can be improved. When the content of the crystalline polyester resin C in the resin particles is 20 parts by mass or less, a deterioration of the heat-resistant storage stability and the occurrence of image fogging can be prevented. When the content of the crystalline polyester resin C in the resin particles is within the above-mentioned more preferred range, it is advantageous in that both high image quality and excellent fixability at low temperatures can be obtained.

### Colorant

The colorant is not particularly limited and can be appropriately selected according to a purpose. Examples of the colorant include, but are not limited to, carbon black, nigrosine dye, iron black, Naphthol Yellow S, Hansa Yellow (10G, 5G, G), Cadmium Yellow, yellow iron oxide, ocher, chrome yellow, titanium yellow, Polyazo Yellow, Oil Yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, ANTHRAZANE Yellow BGL, Isoindolinone Yellow, red iron oxide, red lead, lead vermilion, Cadmium Red, Cadmium-Mercury Red, antimony vermilion, Permanent Red 4R, Para Red, Faise Red, para-chloro ortho-nitroaniline Red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubin B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, Bon Maroon Light, Bon Maroon Medium, Eosin Lake, Rhodamine Lake B, Rhodamine Lake Y, Alizarin Lake, Thioindigo Red B, Thioindigo Maroon, Oil Red, Quinacridone Red, Pyrazolone Red, Polyazole Red, Chrome Vermilion, Benzidine Orange, Perinone Orange, Oil Orange, Cobalt Blue, Cerulean Blue, Alkali Blue Lake, Peacock Blue Lake, Victoria Blue Lake, metal-free Phthalocyanine Blue, Phthalocyanine Blue, Fast Sky Blue, Indanthrene Blue (RS, BC), indigo, ultramarine blue, Prussian blue, Anthraquinone Blue, Fast Violet B, Methyl Violet Lake, cobalt violet, manganese violet, Dioxane Violet, Anthraquinone Violet, Chrome Green, Zinc Green, chromium oxide, Viridian, Emerald Green, Pigment Green B, Naphthol Green B, Green Gold, Acid Green Lake, Malachite Green Lake, Phthalocyanine Green, Anthraquinone Green, titanium oxide, zinc white, and lithopone. These colorants may be used alone or in combination of two or more types.

The content of the colorant in the resin particles is not particularly limited and can be appropriately selected according to a purpose. However, the content is preferably 1 part by mass or more and 15 parts by mass or less, and more preferably 3 parts by mass or more and 10 parts by mass or less, with respect to 100 parts by mass of the resin particles.

The colorant may also be compounded with a resin to be used as a masterbatch.

The resin to be manufactured with the masterbatch or kneaded with the masterbatch is not particularly limited and can be appropriately selected according to a purpose. Examples of the resin include, in addition to the above-described amorphous polyester resin, a polymer of styrene or a substituted styrene, a styrene-based copolymer, polymethyl methacrylate, polybutyl methacrylate, polyvinyl chloride, polyvinyl acetate, polyethylene, polypropylene, polyester, an epoxy resin, an epoxy polyol resin, polyurethane, polyamide, polyvinyl butyral, a polyacrylic resin, rosin, modified rosin, terpene resin, an aliphatic or alicyclic hydrocarbon resin, an aromatic petroleum resin, chlorinated paraffin, and paraffin wax. These resins may be used alone or in combination of two or more types.

Examples of the polymer of styrene or a substituted styrene include, but are not limited to, polystyrene, poly-p-chlorostyrene, and polyvinyltoluene.

Examples of the styrene-based copolymer include, but are not limited to, styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-α-chloromethyl methacrylate copolymer, styrene-acrylonitrile copolymer, styrene-methyl vinyl ketone copolymer, styrene-butadiene copolymer, styrene-isoprene copolymer, styrene-acrylonitrile-indene copolymer, styrene-maleic acid copolymer, and styrene-maleic acid ester copolymer.

A method of manufacturing the masterbatch is not particularly limited and can be appropriately selected according to a purpose. An example of the method includes a method in which the resin for the masterbatch and the colorant are mixed and kneaded by applying high shear force, to manufacture a masterbatch. At this time, an organic solvent can be used to enhance the interaction between the colorant and the resin. Further, a so-called flushing method is preferably used, because in this method, a wet cake of the colorant can be used without being dried. In the flushing method, an aqueous paste of the colorant including water is mixed and kneaded with a resin and an organic solvent. The colorant is transferred to the resin side, and the water and organic solvent components are removed. In the mixing and kneading, a high-shear dispersing device such as a three-roll mill is preferably used.

### Release Agent

The release agent is not particularly limited and can be appropriately selected from known release agents. Examples of the release agent include, but are not limited to, waxes, fatty acid amides, homopolymers or copolymers of polyacrylate, and crystalline polymers having long alkyl groups in a side chain. These release agents may be used alone or in combination of two or more types. These release agents are soluble in chloroform.

Examples of the waxes include, but are not limited to, natural waxes, synthetic hydrocarbon waxes, and synthetic waxes.

Examples of the natural waxes include, but are not limited to, vegetable waxes, animal waxes, mineral waxes, and petroleum waxes.

Examples of the vegetable waxes include, but are not limited to, carnauba wax, cotton wax, and Japan wax.

Examples of the animal waxes include, but are not limited to, beeswax and lanolin.

Examples of the mineral waxes include, but are not limited to, ozokerite and ceresin.

The petroleum waxes include, but are not limited to, paraffin, microcrystalline wax, and petrolatum.

The synthetic hydrocarbon waxes include, but are not limited to, Fischer-Tropsch wax or polyethylene wax.

The synthetic waxes include, but are not limited to, esters, ketones, and ethers.

Examples of the fatty acid amide include, but are not limited to, 12-hydroxystearic acid amide, stearic acid amide, phthalic anhydride imide, and chlorinated hydrocarbons.

Examples of the polyacrylate include, but are not limited to, poly-n-stearyl methacrylate or poly-n-lauryl methacrylate, which are crystalline polymer resins having low molecular weight.

Examples of the homopolymer or copolymer of polyacrylate include, but are not limited to, an n-stearyl acrylate-ethyl methacrylate copolymer.

Among these release agents, the release agent is preferably a vegetable wax or an ester wax obtained by using a material derived from a plant. When the release agent is derived from a plant, the carbon neutrality can be improved.

The melting point of the release agent is not particularly limited and can be appropriately selected according to a purpose. However, the melting point is preferably 60° C. or higher and 80° C. or lower. When the melting point of the release agent is 60° C. or higher, the release agent can be prevented from melting at low temperatures, and thus, deterioration of the heat-resistant storage stability can be prevented. In a case where the melting point of the release agent is 80° C. or lower, when the resin melts and is in the fixing temperature range, the release agent does not melt sufficiently. Therefore, the occurrence of fixing offset and image defects can be prevented.

The content of the release agent in the resin particles is not particularly limited and can be appropriately selected according to a purpose. However, the content is preferably 2 parts by mass or more and 10 parts by mass or less, and more preferably 3 parts by mass or more and 8 parts by mass or less, with respect to 100 parts by mass of the resin particles. When the content of the release agent is 2 parts by mass or more, a deterioration of the high-temperature offset resistance and fixability at low temperatures during fixing can be prevented. When the content of the release agent is 10 parts by mass or less, a deterioration in the heat-resistant storage stability and the occurrence of image fogging can be prevented. When the content of the release agent is within the above-mentioned more preferable range, it is advantageous in that the image quality and the fixing stability can be improved.

### Charge Control Agent

The charge control agent is not particularly limited and can be appropriately selected according to a purpose. Examples of the charge control agent include, but are not limited to, nigrosine dyes, triphenylmethane dyes, metal complex dyes containing chromium, molybdic acid chelate pigments, rhodamine dyes, alkoxy amines, quaternary ammonium salts (including fluorine-modified quaternary ammonium salts), alkylamides, phosphorus alone or as a compound, tungsten alone or as a compound, fluorine-based activators, metal salts of salicylic acid, metal salts of derivatives of salicylic acid, metal salts of oxynaphthoic acid, phenol-based condensates, azo-based pigments, boron complexes, and polymer compounds having functional groups (such as sulfonic acid groups, carboxyl groups, and quaternary ammonium salts). These charge control agents may be used alone or in combination of two or more types.

Specific examples of the charge control agent include, but are not limited to, BONTRON 03 which is a nigrosine dye, BONTRON P-51 which is a quaternary ammonium salt, BONTRON S-34 which is a metal-containing azo dye, E-82 which is an oxynaphthoic acid metal complex, E-84 which is a salicylic acid metal complex, and E-89 which is a phenol condensate (all manufactured by Orient Chemical Industries Co., Ltd.), TP-302 and TP-415 which are quaternary ammonium salt molybdenum complexes (both manufactured by Hodogaya Chemical Co., Ltd.), LRA-901, LR-147 which is a boron complex (manufactured by Japan Carlit Co., Ltd.), copper phthalocyanine, perylene, quinacridone, and azo pigments.

The content of the charge control agent is not particularly limited and can be appropriately selected according to a purpose. However, the content is preferably 0.1 parts by mass or more and 10 parts by mass or less, and more preferably from 0.2 parts by mass to 5 parts by mass, with respect to 100 parts by mass of the resin particles. When the content of the charge control agent is 10 parts by mass or less with respect to 100 parts by mass of the resin particles, the chargeability of the toner containing the resin particles can be prevented from excessively increasing, the effect of the charge control agent can be maintained, an increase of the electrostatic attraction force with the developing roller can be prevented, and a decrease in the fluidity of the developer and in the image density can be prevented. These charge control agents may be melt-kneaded together with the masterbatch and the resin, and then, dissolved and dispersed. Alternatively, the charge control agents may be directly dissolved and dispersed in an organic solvent and then added, or may be fixed to the surface of the resin particles after the resin particles are formed.

### Fluidity Improver

The fluidity improver is not particularly limited and can be appropriately selected according to a purpose, as long as the fluidity improver can be used in a surface treatment to increase the hydrophobicity and prevent the deterioration of flowability characteristics and charging characteristics even under high humidity. Examples of the fluidity improver include, but are not limited to, silane coupling agents, silylating agents, silane coupling agents having a fluorinated alkyl group, organic titanate coupling agents, aluminum-based coupling agents, silicone oil, and modified silicone oil. These fluidity improvers may be used alone or in combination of two or more types.

The content of the fluidity improver is not particularly limited and can be appropriately selected according to a purpose. However, the content is preferably 0.01 parts by mass or more and 5.00 parts by mass or less, and more preferably 0.10 parts by mass or more and 2.00 parts by mass or less, with respect to 100 parts by mass of the resin particles.

### Cleanability Improver

The cleanability improver is used to remove developer remaining on the photoconductor or the primary transfer medium after transfer.

The cleanability improver is not particularly limited and can be appropriately selected according to a purpose. Examples of the cleanability improver include, but are not limited to, fatty acid metal salts and polymer fine particles. These cleanability improvers may be used alone or in combination of two or more types.

Examples of the fatty acid metal salt include, but are not limited to, zinc stearate, calcium stearate, and stearic acid.

The polymer fine particles are preferably polymer fine particles manufactured by soap-free emulsion polymerization, and examples thereof include, but are not limited to, polymethyl methacrylate fine particles and polystyrene fine particles.

The volume average particle diameter of the polymer fine particles is not particularly limited and can be appropriately selected according to a purpose. However, the particle size distribution is preferably relatively narrow, and the volume average particle diameter is preferably from 0.01 μm to 1 μm.

The content of the cleanability improver is not particularly limited and can be appropriately selected according to a purpose. However, the content is preferably 0.01 parts by mass or more and 5.00 parts by mass or less, and more preferably 0.10 parts by mass or more and 2.00 parts by mass or less, with respect to 100 parts by mass of the resin particles.

### Magnetic Material

The magnetic material is not particularly limited and can be appropriately selected according to a purpose. Examples of the magnetic material include, but are not limited to, iron powder, magnetite, and ferrite. These magnetic materials may be used alone or in combination of two or more types. Among these magnetic materials, a magnetic material of white color is preferred in terms of color tone.

The content of the magnetic material is not particularly limited and can be appropriately selected according to a purpose. However, the content is preferably 20 parts by mass or more and 200 parts by mass or less, and more preferably 40 parts by mass or more and 150 parts by mass or less, with respect to 100 parts by mass of the resin particles.

### Deforming Agent

The deforming agent is added with the aim of deforming the shape of the resin particles.

The deforming agent is not particularly limited and can be appropriately selected according to a purpose. However, it is preferable that the deforming agent contains a layered inorganic mineral in which at least a part of the ions between the layers of the layered inorganic mineral are modified with organic ions.

The layered inorganic mineral in which at least a part of the ions between layers of the layered inorganic mineral are modified with organic ions is not particularly limited and can be appropriately selected according to a purpose. Examples thereof include, but are not limited to, minerals having a basic crystal structure of smectite type modified with organic cations. In smectite clay minerals, the layers carry a negative charge, and cations exist between the layers to compensate for the negative charge. An intercalation compound can be formed by the ion exchange of the cations or the adsorption of polar molecules. Moreover, a part of the divalent metal of the layered inorganic mineral may be substituted with a trivalent metal to introduce metal ions. However, when metal anions are introduced, the hydrophilicity increases. Therefore, layered inorganic compounds in which at least a part of the metal anions is modified with organic anions are preferred.

The layered inorganic mineral in which at least a part of the interlayer ions of the layered inorganic mineral are modified with organic ions can be obtained by using an organic cationic modifier or an organic anionic modifier.

The organic cationic modifier is not particularly limited, as long as the organic cationic modifier can modify ions with organic ions as described above. Examples of the organic cationic modifier include, but are not limited to, quaternary alkyl ammonium salts, phosphonium salts, and imidazolium salts. These modifiers may be used alone or in combination of two or more types. Among these modifiers, the organic cationic modifier is preferably a quaternary alkyl ammonium salt.

The quaternary alkyl ammonium salt is not particularly limited, and examples thereof include, but are not limited to, trimethylstearyl ammonium, dimethylstearylbenzyl ammonium, and oleylbis(2-hydroxyethyl)methyl ammonium.

The organic anionic modifier is not particularly limited, as long as the organic anionic modifier can modify ions with organic ions as described above. Examples of the organic anionic modifier include, but are not limited to, sulfates, sulfonates, carboxylates, and phosphates having a branched, unbranched, or cyclic alkyl (C1 to C44) group, a branched, unbranched, or cyclic alkenyl (C1 to C22) group, a branched, unbranched, or cyclic alkoxy (C8 to C32) group, a branched, unbranched, or cyclic hydroxyalkyl (C2 to C22) group, an ethylene oxide backbone, or a propylene oxide backbone. These modifiers may be used alone or in combination of two or more types. Among these modifiers, the organic anionic modifier is preferably a carboxylic acid having an ethylene oxide backbone.

When the resin particles are manufactured as described later in (Method of Manufacturing Resin Particles), the deforming agent is preferably added in an “oil phase preparation step” described later.

By modifying at least a part of the ions between the layers of the layered inorganic mineral with organic ions, suitable hydrophobicity is obtained, so that an oil phase containing the material of the resin particles has non-Newtonian viscosity, and the deforming agent can deform the resin particles. In this case, the content of the deforming agent in the material of the resin particles is preferably from 0.05 mass % to 10 mass %, and more preferably from 0.05mass % to 5 mass %, with respect to the total amount of the material of the resin particles.

The layered inorganic mineral is not particularly limited and can be appropriately selected according to a purpose. Examples thereof include, but are not limited to, montmorillonite, bentonite, hectorite, attapulgite, sepiolite, and mixtures of these minerals.

Among these minerals, organically modified montmorillonite and organically modified bentonite are preferred because in these minerals, the layered inorganic mineral in which at least a part of the ions between layers of the layered inorganic mineral are modified with organic ions does not affect the toner properties when the resin particles are utilized in a toner, the viscosity can be easily adjusted, and the added amount of mineral can be reduced.

Examples of commercially available products of layered inorganic minerals in which at least a part of the ions between layers of the layered inorganic minerals are modified with organic ions include, but are not limited to, quaternium-18 bentonites such as BENTONE 3, BENTONE 38, BENTONE 38V (all manufactured by Rheox, Inc.), TIXOGEL VP (manufactured by United Catalyst, Inc.), CLAYTONE 34, CLAYTONE 40, and CLAYTONE XL (all manufactured by Southern Clay, Inc.); stearalkonium bentonites such as BENTONE 27 (manufactured by Rheox, Inc.), TIXOGEL LG (manufactured by United Catalyst, Inc.), CLAYTONE AF, and CLAYTONE APA (both manufactured by Southern Clay, Inc.); and quaternium-18/benzalkonium bentonites such as CLAYTONE HT and CLAYTONE PS (both manufactured by Southern Clay, Inc.). Among these commercially available products, CLAYTONE AF and CLAYTONE APA are preferable.

More preferred examples of the layered inorganic mineral in which at least a part of the ions between layers of the layered inorganic mineral are modified with organic ions include, but are not limited to, a layered inorganic mineral obtained by modifying DHT-4A (registered trademark) (manufactured by Kyowa Chemical Industry Co., Ltd.) with an organic anionic modifier represented by General Formula (III) below.

An example of the organic anionic modifier represented General Formula (III) below includes, but is not limited to, HITENOL (registered trademark) 330T (manufactured by DKS Co., Ltd.).

R₁(OR₂)ₙOSO₃M General Formula (III)

(in General Formula (III), R₁ represents an alkyl group having 13 carbon atoms, R₂ represents an alkylene group having 2 to 6 carbon atoms, n represents an integer of 2 to 10, and M represents a monovalent metal element)

### Volume Average Particle Diameter of Resin Particles

The volume average particle diameter (D4) of the resin particles is not particularly limited and can be appropriately selected according to a purpose, but is preferably 3 μm or more and 7 μm or less.

A ratio (D4/Dn) of the volume average particle diameter (D4) of the resin particles with respect to the number average particle diameter (Dn) of the resin particles is not particularly limited and can be appropriately selected according to a purpose, but is preferably 1.2 or less.

The resin particles preferably contain components having a volume average particle diameter of 2 μm or less in an amount of 1% by number or more and 10% by number or less.

The volume average particle diameter (D4), the number average particle diameter (Dn), and the ratio thereof (D4/Dn) in the resin particles can be measured by using, for example, a COULTER COUNTER TA-II or a COULTER MULTISIZER II (both manufactured by Coulter Inc.). The values mentioned herein were obtained by using a COULTER MULTISIZER II. The measurement method is described below.

First, 0.1 mL to 5 mL of a surfactant (preferably polyoxyethylene alkyl ether (a nonionic surfactant)) is added as a dispersant to 100 mL to 150 mL of an aqueous electrolyte solution, to obtain a mixed solution. 2 mg to 20 mg of a measurement sample is further added to the mixed solution. An aqueous electrolyte solution in which the measurement sample is suspended is subjected to a dispersion treatment using an ultrasonic disperser for about 1 to 3 minutes, and the volume and the number of the resin particles are measured by using the measurement device (COULTER MULTISIZER II) with an aperture of 100 μm, to calculate the volume distribution and the number distribution. From the obtained distributions, it is possible to determine the volume average particle diameter (D4) and the number average particle diameter (Dn) of the resin particles.

The aqueous electrolyte solution is obtained by using high-grade sodium chloride to prepare a 1 mass % aqueous solution of sodium hydrochloride. For example, it is possible to use ISOTON-II (manufactured by Coulter Inc.).

As the channels, thirteen channels are used, that is, 2.00 μm or more and less than 2.52 μm, 2.52 μm or more and less than 3.17 μm; 3.17 μm or more and less than 4.00 μm, 4.00 μm or more and less than 5.04 μm, 5.04 μm or more and less than 6.35 μm, 6.35 μm or more and less than 8.00 μm, 8.00 μm or more and less than 10.08 μm, 10.08 μm or more and less than 12.70 μm, 12.70 μm or more and less than 16.00 μm, 16.00 μm or more and less than 20.20 μm, 20.20 μm or more and less than 25.40 μm, 25.40 μm or more and less than 32.00 μm, and 32.00 μm or more and less than 40.30 μm. The target particles are particles having a particle diameter of 2.00 μm or more and less than 40.30 μm.

### Glass Transition Temperature (Tg) and Melting Point (Tm)

### Measurement Method of Glass Transition Temperature (Tg) and Melting Point (Tm)

Herein, the glass transition temperature (Tg) and the and melting point (Tm) can be measured, for example, by using a differential scanning calorimeter (DSC) system (“Q-200”, manufactured by TA Instruments).

Specifically, the glass transition temperature (Tg) and the melting point (Tm) of a target sample can be measured by the following procedure.

First, about 5.0 mg of a target sample is filled into a sample container made of aluminum, and the sample container is placed on a holder unit and set in an electric furnace. Next, in a nitrogen atmosphere, the sample is heated from −80° C. to 150° C. at a heating rate of 10° C./min (first temperature increase). Afterwards, the sample is cooled from 150° C. to −80° C. at a cooling rate of 10° C./min, and then, heated again to 150° C. at a heating rate of 10° C./min (second temperature increase). During each of the first temperature increase and the second temperature increase, a DSC curve is measured by using a differential scanning calorimeter (“Q-200”, manufactured by TA Instruments).

From the obtained DSC curves, the DSC curve at the first temperature increase can be selected by using the analysis program in the Q-200 system, to determine the glass transition temperature of the target sample at the first temperature increase. Similarly, the DSC curve at the second temperature increase can be selected to determine the glass transition temperature of the target sample at the second temperature increase.

Further, from the obtained DSC curves, the DSC curve during the first temperature increase can be selected by using the analysis program in the Q-200 system, to determine the endothermic peak top temperature at the first temperature increase of the target sample as the melting point. Similarly, the DSC curve at the second temperature increase can be selected, to determine the endothermic peak top temperature during the second temperature increase of the target sample as the melting point.

Herein, when resin particles are used as the target sample, the glass transition temperature at the first temperature increase is defined as [Tg1st], and the glass transition temperature at the second temperature increase is defined as [Tg2nd].

In the present specification, unless otherwise specified, the endothermic peak top temperature during the second temperature increase is defined as the melting point of each target sample, and Tg during the second temperature increase is defined as the Tg of each target sample, relating to the glass transition temperature and the melting point of the amorphous polyester resin A, the amorphous polyester resin B, the crystalline polyester resin C, and other components such as the release agent.

### Tg1st (Resin Particles)

The glass transition temperature of the resin particles at the first temperature increase in differential scanning calorimetry (DSC) [Tg1st (resin particles)] is not particularly limited and can be appropriately selected according to a purpose. However, from the viewpoint of fixability at low temperatures, the glass transition temperature is preferably 20° C. or higher and 50° C. or lower, and more preferably 35° C. or higher and 45° C. or lower. When the above-mentioned [Tg1st (resin particles)] is 20° C. or higher, it is possible to suppress a decrease in the heat-resistant storage stability, blocking in the developing device, and filming on the photoconductor. When the [Tg1st (resin particles)] is 50° C. or less, it is possible to prevent a decrease in the fixability at low temperatures of the resin particles.

Conventionally, when the glass transition temperature (Tg) of a toner is about 50° C. or less, the toner is likely to aggregate due to temperature changes during transportation and storage during summer or in tropical regions. As a result, the toner may solidify in a toner bottle and adhere to the interior of a developing device. Further, due to the toner getting stuck in the toner bottle, the toner supply may be insufficient, and when the toner adheres to the interior of the developing device, image abnormality easily occurs.

Even when the glass transition temperature (Tg) of the toner containing the resin particles is lower than that of a conventional toner, the heat-resistant storage stability of the toner can be maintained if the amorphous polyester resin A, which serves as a component having a low Tg in the toner, is non-linear. In particular, when the amorphous polyester resin

A has a urethane bond or a urea bond having a high cohesive force, the effect of maintaining the heat-resistant storage stability is more pronounced.

### [Tg2nd (Resin Particles)]

The glass transition temperature of the resin particles at the second temperature increase in differential scanning calorimetry (DSC) [Tg2nd (resin particles)] is not particularly limited and can be appropriately selected according to a purpose. However, the glass transition temperature is preferably 0° C. or higher and 30° C. or lower, and more preferably 0° C. or higher and 15° C. or lower. When the above-mentioned [Tg2nd (resin particles)] is 0° C. or higher, the blocking resistance of a fixed image (printed matter) can be prevented from decreasing. When the [Tg2nd (resin particles)] is 30° C. or lower, it is possible to prevent a decrease in the fixability at low temperatures and the glossiness.

The value of [Tg2nd (resin particles)] can be adjusted by the Tg of the crystalline resin and the blending amount, for example.

### Difference [[Tg1st (Resin Particles)]−[Tg2nd (Resin Particles)]]

The difference between the glass transition temperature at the first temperature increase [Tg1st (resin particles)] and the glass transition temperature at the second temperature increase [Tg2nd (resin particles)] of the resin particles in differential scanning calorimetry (DSC), that is, [[Tg1st (resin particles)]−[Tg2nd (resin particles)]], is not particularly limited and can be appropriately selected according to a purpose, but is preferably 10° C. or more. The upper limit of the above-mentioned difference [[Tg1st (resin particles)]−[Tg2nd (resin particles)]] is not particularly limited and can be appropriately selected according to a purpose, but is preferably 50° C. or less.

The difference [[Tg1st (resin particles)]−[Tg2nd (resin particles)]] is preferably 10° C. or more, because in this case, the fixability at low temperatures is excellent. Further, when the difference [Tg1st (resin particles)]−[Tg2nd (resin particles)] is 10° C. or more, the crystalline polyester resin C, which is incompatible before heating (before the first temperature increase), and the amorphous polyester resin A and the amorphous polyester resin B are compatible after heating (after the first temperature increase). Note that, after heating, the components may not be completely compatible with each other.

### Tg2nd (Portion Insoluble in THF)

The glass transition temperature of a portion of the resin particles that is insoluble in tetrahydrofuran (THF) at the second temperature increase in differential scanning calorimetry (DSC) [Tg2nd (THF-insoluble portion)] is not particularly limited and can be appropriately selected according to a purpose. However, the glass transition temperature is preferably −40° C. or higher and 30° C. or lower, and more preferably 0° C. or higher and 20° C. or lower. When the above-mentioned [Tg2nd (THF-insoluble portion)] is −40° C. or higher, the blocking resistance of the fixed image (printed matter) can be prevented from decreasing, which is advantageous. When the [Tg2nd (THF-insoluble portion)] is 30° C. or lower, the fixability at low temperatures and the glossiness can be prevented from decreasing, which is advantageous.

For example, the value of [Tg2nd (THF-insoluble portion)] can be adjusted by changing the number of carbon atoms in the polyhydric alcohol and the polycarboxylic acid in the amorphous polyester resin A.

### Melting Point (Tm)

The melting point (Tm) of the resin particles is not particularly limited and can be appropriately selected according to a purpose. However, the melting point is preferably 60° C. or higher and 80° C. or lower.

### Storage Modulus

### Method of Measuring Storage Modulus G′

The storage modulus (G′) under various conditions can be measured by using a dynamic viscoelasticity measuring device (ARES, manufactured by TA Instruments), for example. The frequency during the measurement was 1 Hz.

Specifically, a measurement sample is molded into a pellet having a diameter of 8 mm and a thickness of 1 mm to 2 mm. The obtained pellet is fixed to a parallel plate having a diameter of 8 mm. Subsequently, the pellet is stabilized at 40° C. and heated to 200° C. at a heating rate of 2.0° C./min at a frequency of 1 Hz (6.28 rad/s) and a strain amount of 0.1% (strain amount control mode) to measure the storage modulus.

Herein, the storage modulus at 40° C. may be expressed by [G′(40)], and the storage modulus at 100° C. may be expressed by [G′(100)].

### [G′(100) (THF-Insoluble Portion)] and [[G′(40) (THF-Insoluble Portion)]/[G′(100) (THF-Insoluble Portion)]]

The storage modulus of the portion of the resin particles insoluble in tetrahydrofuran (THF) at 100° C. [G′(100) (THF-insoluble portion)] is not particularly limited and can be appropriately selected according to a purpose, but is preferably from 1.0*10⁵ Pa to 1.0*10⁷ Pa, and more preferably from 5.0*10⁵ Pa to 5.0*10⁶ Pa. When the storage modulus [G′(100) (THF-insoluble portion)] is within the above-mentioned more preferable range, even more excellent fixability at low temperatures can be obtained, which is advantageous.

A ratio of the storage modulus at 40° C. [G′(40) (THF-insoluble portion)] to the storage modulus at 100° C. [G′(100) (THF-insoluble portion)] of the portion of the resin particles insoluble in THE, that is, [G′(40) (THF-insoluble portion)]/[G′(100) (THF-insoluble portion)], is not particularly limited and can be appropriately selected according to a purpose, but is preferably 3.5*10 or less. When the above-described ratio [[G′(40) (THF-insoluble portion)]/[G′(100) (THF-insoluble portion)]] is 3.5*10 or less, it is possible to suppress a decrease in the fixability at low temperatures.

When the [G′(100) (THF insoluble-portion)] of the resin particles is from 1.0*10⁵ Pa to 1.0*10⁷ Pa and the ratio [[G′(40) (THF-insoluble portion)/G′(100) (THF-insoluble portion)]] of the resin particles is 3.5*10 or less, the resin particles promote compatibility between the crystalline resin and the amorphous polyester resin, which serves as a component having a high Tg, and the half outflow temperature measured by a thermal flow evaluation device (flow tester) is reduced, which is advantageous in improving image gloss.

The values of [G′(100) (THF-insoluble portion)] and [G′(40) (THF-insoluble portion)] can be adjusted by the resin composition (difunctional or higher polyhydric alcohol and difunctional or higher acid components), for example.

Specifically, the values can be adjusted as described below, for example. To increase the storage modulus (G′), the values can be adjusted by shortening the distance between ester bonds in the resin or by using a resin composition having an aromatic ring. To reduce the storage modulus (G′), the values can be adjusted by using a linear polyester resin or by using, as a constituent component of a polyester resin, a polyhydric alcohol having an alkyl group in a side chain.

### THF-Insoluble Portion

The THF-insoluble portion of the resin particles can be obtained as described below.

One part of resin particles is added to 100 parts of tetrahydrofuran (THF), and the mixture is refluxed for 6 hours. Subsequently, insoluble components are precipitated by using a centrifuge to separate the insoluble components and the supernatant.

### Measurement of Molecular Weight

The molecular weight of each constituent component of the resin particles can be measured under the following analytical conditions, for example.

### Analytical Conditions

Gel permeation chromatography (GPC) measurement device: GPC-8220GPC (manufactured by Tosoh Corporation)

### Column: TSKgel (registered trademark) Super HZM-H 15 cm triple column (manufactured by Tosoh Corporation)

Temperature: 40° C.
Detector: refractive index (RI) detector
Solvent: Chloroform
Flow rate: 0.35 mL/min
Sample: 100 μL of 0.1 mass % sample injected
Sample pretreatment: The resin particles are dissolved in chloroform at 0.1 mass %, and then, the mixture is stirred at 25° C. for 30 minutes to obtain a solution in which the soluble components are dissolved. The solution is filtered through a membrane filter having openings of 0.2 μm, and the filtrate is used as a chloroform sample solution.

100 μL of the chloroform sample solution is injected into a measurement device to perform measurement.

In the measurement of the molecular weight of a sample, the molecular weight distribution of the sample is calculated from the relationship between the count number and the logarithmic value of a calibration curve prepared by using several types of monodispersed polystyrene standard samples. SHODEX (registered trademark) STANDARD Std. No. S-6550, S-1700, S-740, S-321, S-129, S-10, S-2.9, and S-0.6 (manufactured by Showa Denko K.K.) are used as polystyrene standard samples for preparing a calibration curve.

A method of manufacturing the polyester water dispersion is not particularly limited. The polyester water dispersion is preferably manufactured by the method of manufacturing a polyester water dispersion of the present disclosure described below.

### Method of Manufacturing Polyester Water Dispersion

The method of manufacturing a polyester water dispersion of the present disclosure includes: a) a step of preparing an oil phase by dissolving or dispersing the amorphous polyester resin A having a sulfo group in an organic solvent (may be referred to as “oil phase preparation step” hereinafter), and b) a step of adding an aqueous medium to the oil phase to cause phase inversion from a water-in-oil dispersion liquid to an oil-in-water dispersion liquid (may be referred to as “phase inversion emulsification step” hereinafter). If desired, the method of manufacturing a polyester water dispersion further includes other steps such as an aqueous phase preparation step and a solvent removal step.

### Oil Phase Preparation Step

The oil phase preparation step is a step of preparing an oil phase by dissolving or dispersing at least the amorphous polyester resin A having a sulfo group, in an organic solvent.

The characteristics of the amorphous polyester resin A having a sulfo group are described above in the section <<Amorphous Polyester Resin A>>, and the oil phase contains the amorphous polyester resin A.

The organic solvent is not particularly limited and can be appropriately selected according to a purpose. However, an organic solvent having a boiling point of less than 150° C. is preferred to easily remove the organic solvent.

The organic solvent having a boiling point of less than 150° C. is not particularly limited and can be appropriately selected according to a purpose. Examples thereof include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These organic solvents may be used alone or in combination of two or more types. Among these organic solvents, ethyl acetate, toluene, xylene, benzene, methylene chloride, 1,2-dichloroethane, chloroform, or carbon tetrachloride are preferable, and ethyl acetate is more preferable as the organic solvent.

The amount of the organic solvent being used is not particularly limited and can be appropriately selected according to a purpose, but is preferably 40 parts by mass or more and 300 parts by mass or less, more preferably 60 parts by mass or more and 140 parts by mass or less, and even more preferably 80 parts by mass or more and 120 parts by mass or less, with respect to 100 parts by mass of the raw material of the resin particles.

A method of preparing the oil phase is not particularly limited and can be appropriately selected according to a purpose. An example of the method includes a method in which materials of the oil phase is gradually added to the organic solvent while stirring the organic solvent to dissolve or disperse the materials.

To disperse the materials, known dispersers such as a bead mill and a disk mill can be used.

### Aqueous Phase (Aqueous Medium) Preparation Step

The aqueous phase preparation step is a step of preparing an aqueous phase (aqueous medium).

The aqueous medium is not particularly limited, can be appropriately selected according to a purpose, and examples thereof include, but are not limited to, water, a solvent miscible with water, and a mixture thereof. These aqueous media may be used alone or in combination of two or more types. Among these aqueous media, water is preferred.

The solvent miscible in water is not particularly limited, can be appropriately selected according to a purpose, and examples thereof include, but are not limited to, alcohol, dimethylformamide, tetrahydrofuran, ethyl acetate, CELLOSOLVE solvents, and lower ketones.

The alcohol is not particularly limited, can be appropriately selected according to a purpose, and examples of the alcohol include, but are not limited to, methanol, isopropanol, and ethylene glycol.

The lower ketones are not particularly limited, can be appropriately selected according to a purpose, and examples thereof include, but are not limited to, acetone and methyl ethyl ketone.

### Phase Inversion Emulsification Step

The phase inversion emulsification step is a step of adding an aqueous medium to the oil phase to cause phase inversion from a water-in-oil dispersion liquid to an oil-in-water dispersion liquid. Thus, a polyester water dispersion (oil droplets) is obtained.

A method of subjecting the amorphous polyester resin A to phase inversion emulsification in the above-described aqueous medium is not particularly limited and can be appropriately selected according to a purpose. Examples of the method include a method in which an oil phase is neutralized with a base or the like, an aqueous phase is added thereto, and a polyester water dispersion is obtained by phase inversion emulsification in which a water-in-oil dispersion liquid is inverted into an oil-in-water dispersion liquid.

As a base used for neutralizing the oil phase, any one of a basic inorganic compound and a basic organic compound may be used. Examples of the basic inorganic compound include, but are not limited to, sodium hydroxide, potassium hydroxide, lithium hydroxide, ammonia, sodium carbonate, sodium hydrogen carbonate, potassium carbonate, potassium hydrogen carbonate, and ammonia. Examples of the basic organic compound include, but are not limited to, N,N-dimethylethanolamine, N,N-diethylethanolamine, triethanolamine, tripropanolamine, tributanolamine, triethylamine, n-propylamine, n-butylamine, isopropylamine, monomethanolamine, morpholine, methoxypropylamine, pyridine, vinylpyridine, and isophoronediamine.

The phase inversion emulsification is implemented while uniformly mixing and dispersing the mixture by using a general-use stirrer or a dispersing device during neutralization. The dispersing device is not particularly limited, and examples thereof include, but are not limited to, an ultrasonic disperser, a bead mill, a ball mill, a roll mill, a HOMO MIXER, an ULTRA MIXER, a disperser mixer, a penetrating-type high-pressure dispersing device, a collision-type high-pressure dispersing device, a multi-hole type high-pressure dispersing device, an ultra-high pressure homogenizer, and an ultrasonic homogenizer. A general-use stirrer and a dispersing device may be used in combination.

The amount of the aqueous medium being used when the oil phase containing the amorphous polyester resin A is subjected to phase inversion emulsification is not particularly limited and can be appropriately selected according to a purpose. The amount of the aqueous medium is preferably 50 parts by mass or more and 2,000 parts by mass or less, and more preferably 100 parts by mass or more and 1,000 parts by mass or less, with respect to 100 parts by mass of the amorphous polyester resin A. When the amount of the aqueous medium being used is 50 parts by mass or more with respect to 100 parts by mass of the amorphous polyester resin A, a degradation of the dispersion state of the material of the resin particles can be prevented, so that the resulting polyester water dispersion can have a predetermined particle diameter. When the amount of the aqueous medium being used is 2,000 parts by mass or less with respect to 100 parts by mass of the amorphous polyester resin A, an increase in production costs can be prevented.

When the oil phase containing the amorphous polyester resin A is subjected to phase inversion emulsification, a dispersant may be used to stabilize the dispersion containing oil droplets etc., form a desired shape, and obtain a narrow particle size distribution.

The dispersant is not particularly limited and can be appropriately selected according to a purpose. Examples of the dispersant include, but are not limited to, surfactants, inorganic compound dispersants poorly soluble in water, and polymer-based protective colloids.

These dispersants may be used alone or in combination of two or more types. Among these dispersants, the dispersant is preferably a surfactant.

The surfactant is not particularly limited and can be appropriately selected according to a purpose. Examples of the surfactant include, but are not limited to, anionic surfactants, cationic surfactants, nonionic surfactants, and amphoteric surfactants.

The anionic surfactants are not particularly limited, can be appropriately selected according to a purpose, and examples thereof include, but are not limited to, alkyl sulfates, alkylbenzene sulfonates, α-olefin sulfonate, and phosphoric acid ester. Among these anionic surfactants, alkyl sulfates are preferred, because alkyl sulfates are less likely to form salts with aggregating salts during the preparation of the resin particles, and thus, the choice of the aggregating salts is broadened.

The amount of the surfactant is preferably 0 mass % or more and 3.0 mass % or less with respect to 100 mass % of the resin particles. When the amount exceeds 3.0 mass %, the shell material is too stable and does not easily attach to the core, and thus, the electrostatic properties of the resin particles are not uniform.

The phase inversion emulsification may be implemented by using a stirring blade.

The stirring blade is not particularly limited and can be appropriately selected according to the viscosity of the solution. Examples of the stirring blade include an anchor blade, a turbine blade, a PFAUDLER blade, a FULLZONE blade, a MAXBLEND blade, and a half-moon blade.

When the stirring blade is used, the peripheral speed is not particularly limited and can be appropriately selected according to a purpose, but is preferably from 0.4 m/sec to 2.0 m/sec, and more preferably from 0.7 m/sec to 1.5 m/sec.

The volume average particle diameter of the polyester water dispersion (oil droplets) is not particularly limited and can be appropriately selected according to a purpose, but is preferably from 20 nm to 200 nm, and more preferably from 20 nm to 100 nm.

### Solvent Removal Step

The solvent removal step is a step of removing the organic solvent from the polyester water dispersion obtained in the phase inversion emulsification step.

A method of removing the organic solvent from the polyester water dispersion is not particularly limited and can be appropriately selected according to a purpose. Examples of the method include a method of gradually increasing the temperature of the entire reaction system to evaporate the organic solvent in the fine particle dispersion liquid (oil droplets); a method of spraying the fine particle dispersion liquid into a dry atmosphere to remove the organic solvent in the fine particle dispersion liquid (oil droplets); and a method of reducing the pressure of the fine particle dispersion liquid to evaporate and remove the organic solvent. These methods may be used alone or in combination of two or more types.

The dry atmosphere into which the fine particle dispersion liquid is sprayed is not particularly limited and can be appropriately selected according to a purpose. Examples of the dry atmosphere include, but are not limited to, air, nitrogen, carbonic acid gas, and gases obtained by heating combustion gases. In general, it is possible to use various types of air flows heated to a temperature equal to or higher than the boiling point of the solvent having the highest boiling point among the solvents being used.

The solvent removal step can be implemented by using a device such as a spray dryer, a belt dryer, and a rotary kiln, and the desired quality can be obtained sufficiently by a treatment having a short duration.

### Method of Manufacturing Resin Particles

A method of manufacturing resin particles of the present disclosure includes: a) a step of preparing an oil phase by dissolving or dispersing at least an amorphous polyester resin in an organic solvent (may be referred to as “oil phase preparation step” hereinafter), b) a step of adding an aqueous medium to the oil phase to cause phase inversion from a water-in-oil dispersion liquid to an oil-in-water dispersion liquid (may be referred to as “phase inversion emulsification step” hereinafter), c) a step of aggregating particles of the oil-in-water dispersion liquid to obtain resin particles (may be referred to as “aggregation step” hereinafter), and d) a step of forming a shell layer. If desired, the method of manufacturing resin particles further includes other steps such as an aqueous phase preparation step, a solvent removal step, a fusion step, a washing step, a drying step, a classification step, and an annealing step.

### Oil Phase Preparation Step

The oil phase preparation step is a step of preparing an oil phase by dissolving or dispersing at least the amorphous polyester resin B in an organic solvent.

The characteristics of the amorphous polyester resin are described above in the part <<Amorphous Polyester Resin B>>, and it is preferable that the oil phase contains the amorphous polyester resin B.

The oil phase may further contain, if desired, the crystalline resin, the colorant, the release agent, and the like, which are descried above.

The organic solvent is not particularly limited and can be appropriately selected according to a purpose. However, an organic solvent having a boiling point of less than 150° C. is preferred to easily remove the organic solvent.

The organic solvent having a boiling point of less than 150° C. is not particularly limited and can be appropriately selected according to a purpose. Examples thereof include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These organic solvents may be used alone or in combination of two or more types. Among these organic solvents, ethyl acetate, toluene, xylene, benzene, methylene chloride, 1,2-dichloroethane, chloroform, and carbon tetrachloride are preferable, and ethyl acetate is more preferable.

The amount of the organic solvent being used is not particularly limited and can be appropriately selected according to a purpose, but is preferably 40 parts by mass or more and 300 parts by mass or less, more preferably 60 parts by mass or more and 140 parts by mass or less, and even more preferably 80 parts by mass or more and 120 parts by mass or less, with respect to 100 parts by mass of the raw material of the resin particles.

A method of preparing the oil phase is not particularly limited and can be appropriately selected according to a purpose. An example of the method includes a method in which a material of the oil phase is gradually added to the organic solvent while stirring the organic solvent to dissolve or disperse the material.

To disperse the material, known dispersers such as a bead mill and a disk mill can be used.

### Aqueous Phase (Aqueous Medium) Preparation Step

The aqueous phase preparation step is a step of preparing an aqueous phase (aqueous medium).

The aqueous medium is not particularly limited, can be appropriately selected according to a purpose, and examples thereof include, but are not limited to, water, a solvent miscible with water, and a mixture thereof. These aqueous media may be used alone or in combination of two or more types. Among these aqueous media, water is preferred.

The solvent miscible in water is not particularly limited, can be appropriately selected according to a purpose, and examples thereof include, but are not limited to, alcohol, dimethylformamide, tetrahydrofuran, ethyl acetate, CELLOSOLVE solvents, and lower ketones.

The alcohol is not particularly limited, can be appropriately selected according to a purpose, and examples of the alcohol include, but are not limited to, methanol, isopropanol, and ethylene glycol.

The lower ketones are not particularly limited, can be appropriately selected according to a purpose, and examples thereof include, but are not limited to, acetone and methyl ethyl ketone.

### Phase Inversion Emulsification Step

The phase inversion emulsification step is a step of adding an aqueous medium to the oil phase to cause phase inversion from a water-in-oil dispersion liquid to an oil-in-water dispersion liquid. Thus, a fine particle dispersion liquid (oil droplets) is obtained.

A method of subjecting the dispersion liquid containing the amorphous polyester resin B to phase inversion emulsification in the above-described aqueous medium is not particularly limited and can be appropriately selected according to a purpose. Examples of the method include a method in which an oil phase is neutralized with a base or the like, and then, an aqueous phase is added thereto, and a fine particle dispersion liquid is obtained by phase inversion emulsification in which a water-in-oil dispersion liquid is inverted into an oil-in-water dispersion liquid.

A method of subjecting the amorphous polyester resin B to phase inversion emulsification in the above-described aqueous medium is not particularly limited and can be appropriately selected according to a purpose. Examples of the method include a method in which an oil phase is neutralized with a base or the like, and then, an aqueous phase is added thereto, and a fine particle dispersion liquid is obtained by phase inversion emulsification in which a water-in-oil dispersion liquid is inverted into an oil-in-water dispersion liquid.

As a base used for neutralizing the oil phase, any one of a basic inorganic compound or a basic organic compound may be used. Examples of the basic inorganic compound include, but are not limited to, sodium hydroxide, potassium hydroxide, lithium hydroxide, ammonia, sodium carbonate, sodium hydrogen carbonate, potassium carbonate, and potassium hydrogen carbonate. Examples of the basic organic compound include, but are not limited to, N,N-dimethylethanolamine, N,N-diethylethanolamine, triethanolamine, tripropanolamine, tributanolamine, triethylamine, n-propylamine, n-butylamine, isopropylamine, monomethanolamine, morpholine, methoxypropylamine, pyridine, vinylpyridine, and isophoronediamine.

The phase inversion emulsification is implemented while uniformly mixing and dispersing the mixture by using a general-use stirrer or a dispersing device during neutralization. The dispersing device is not particularly limited, and examples thereof include, but are not limited to, an ultrasonic disperser, a bead mill, a ball mill, a roll mill, a HOMO MIXER, an ULTRA MIXER, a disperser mixer, a penetrating-type high-pressure dispersing device, a collision-type high-pressure dispersing device, a multi-hole type high-pressure dispersing device, an ultra-high pressure homogenizer, and an ultrasonic homogenizer. A general-use stirrer and a dispersing device may be used in combination.

The amount of the aqueous medium being used when the oil phase containing the material of the resin particles is subjected to phase inversion emulsification is not particularly limited and can be appropriately selected according to a purpose. The amount of the aqueous medium is preferably 50 parts by mass or more and 2,000 parts by mass or less, and more preferably 100 parts by mass or more and 1,000 parts by mass or less, with respect to 100 parts by mass of the material of the resin particles. When the amount of the aqueous medium being used is 50 parts by mass or more with respect to 100 parts by mass of the resin particles, a degradation of the dispersion state of the material of the resin particles can be prevented, so that the resulting resin particles can have a predetermined particle diameter. When the amount of the aqueous medium being used is 2,000 parts by mass or less with respect to 100 parts by mass of the material of the resin particles, an increase in production costs can be prevented.

When the oil phase containing the material of the resin particles is subjected to phase inversion emulsification, it is preferable to use a dispersant to stabilize the dispersion containing oil droplets etc., form a desired shape, and obtain a narrow particle size distribution.

The dispersant is not particularly limited and can be appropriately selected according to a purpose. Examples of the dispersant include, but are not limited to, surfactants, inorganic compound dispersants poorly soluble in water, and polymer-based protective colloids.

These dispersants may be used alone or in combination of two or more types. Among these dispersants, the dispersant is preferably a surfactant.

The surfactant is not particularly limited and can be appropriately selected according to a purpose. Examples of the surfactant include, but are not limited to, anionic surfactants, cationic surfactants, nonionic surfactants, and amphoteric surfactants.

The anionic surfactants are not particularly limited, can be appropriately selected according to a purpose, and examples thereof include, but are not limited to, alkylbenzene sulfonates, α-olefin sulfonate, and phosphoric acid ester. Among these anionic surfactants, alkyl sulfates are preferred as the anionic surfactant.

The phase inversion emulsification may be implemented by using a stirring blade.

The stirring blade is not particularly limited and can be appropriately selected according to the viscosity of the solution. Examples of the stirring blade include an anchor blade, a turbine blade, a PFAUDLER blade, a FULLZONE blade, a MAXBLEND blade, and a half-moon blade.

When the stirring blade is used, the peripheral speed is not particularly limited and can be appropriately selected according to a purpose, but is preferably from 0.4 m/sec to 2.0 m/sec, and more preferably from 0.7 m/sec to 1.5 m/sec.

The volume average particle diameter of the dispersion (oil droplets) in the fine particle dispersion liquid is not particularly limited and can be appropriately selected according to a purpose, but is preferably from 50 nm to 2,000 nm, and more preferably from 50 nm to 500 nm.

### Solvent Removal Step

The solvent removal step is a step of removing the organic solvent from the fine particle dispersion liquid obtained in the phase inversion emulsification step to obtain core particles.

A method of removing the organic solvent from the fine particle dispersion liquid is not particularly limited and can be appropriately selected according to a purpose. Examples of the method include a method of gradually increasing the temperature of the entire reaction system to evaporate the organic solvent in the fine particle dispersion liquid (oil droplets); a method of spraying the fine particle dispersion liquid into a dry atmosphere to remove the organic solvent in the fine particle dispersion liquid (oil droplets); and a method of reducing the pressure of the fine particle dispersion liquid to evaporate and remove the organic solvent. These methods may be used alone or in combination of two or more types.

The dry atmosphere into which the fine particle dispersion liquid is sprayed is not particularly limited and can be appropriately selected according to a purpose. Examples of the dry atmosphere include, but are not limited to, air, nitrogen, carbonic acid gas, and gases obtained by heating combustion gases. In general, it is possible to use various types of air flows heated to a temperature equal to or higher than the boiling point of the solvent having the highest boiling point among the solvents being used.

The solvent removal step can be implemented by using a device such as a spray dryer, a belt dryer, and a rotary kiln, and the desired quality can be obtained sufficiently by a treatment having a short duration.

### Aggregation Step

The aggregation step is a step of aggregating particles in the oil-in-water dispersion liquid to obtain aggregated particles.

A method of aggregating the oil droplets or the core particles is not particularly limited and can be appropriately selected from known methods according to a purpose. Examples of the method include a method of adding an aggregating agent and a method of adjusting the pH.

The aggregating agent is not particularly limited and can be appropriately selected according to a purpose. Examples of the aggregating agent include, but are not limited to, aluminum chloride, zinc sulfate, magnesium sulfate, aluminum sulfate, aluminum potassium sulfate, sodium chloride, sodium bromide, sodium iodide, sodium fluoride, sodium acetate, sodium acetoacetate, lithium chloride, lithium bromide, lithium iodide, lithium fluoride, lithium acetate, lithium acetoacetate, potassium chloride, potassium bromide, potassium iodide, potassium fluoride, potassium acetoacetate, magnesium bromide, magnesium chloride, magnesium iodide, magnesium fluoride, magnesium acetate, magnesium acetoacetate, calcium chloride, calcium bromide, barium bromide, barium chloride, barium iodide, barium fluoride, barium acetate, barium acetoacetate, strontium bromide, strontium chloride, strontium iodide, strontium fluoride, strontium acetate, strontium acetoacetate, zinc bromide, zinc chloride, zinc iodide, zinc fluoride, zinc acetate, zinc acetoacetate, copper bromide, copper chloride, copper iodide, copper fluoride, copper acetate, copper acetoacetate, iron bromide, iron chloride, iron iodide, iron fluoride, iron acetate, and iron acetoacetate. These aggregating agents may be used alone or in combination of two or more types. Among these aggregating agents, the aggregating agent is preferably a divalent metal salt, and more preferably a trivalent metal salt. By using a divalent or higher metal salt, a three-dimensional structure can be formed by cross-linking the metal with carboxyl groups contained in the amorphous polyester resin A or the amorphous polyester resin B. Thus, it is possible to increase the strength of the resin particles and improve the filming resistance.

When the aggregating agent is added, the aggregating agent may be simply added. However, it is preferable to add the aggregating agent as an aqueous solution, because in this case, it is possible to prevent localized high concentration. It is also preferable to gradually add the aggregating salt while monitoring the particle diameter of the resin particles.

The temperature of the reaction system in which the aggregation step is performed (the temperature of the dispersion liquid during aggregation) is not particularly limited and can be appropriately selected according to a purpose. However, the temperature is preferably close to the glass transition temperature (Tg) of the amorphous polyester resin B. When the temperature is too low, the aggregation does not proceed well, which leads to poor efficiency. When the temperature is too high, the aggregation rate increases, which leads to the generation of coarse particles and a deterioration in the particle diameter distribution.

In the aggregation step, the aggregating is stopped when the aggregated particles have a desired particle diameter.

A method of stopping the aggregation is not particularly limited and can be appropriately selected according to a purpose. Examples of the method include a method of adding a salt having a lower ionic valence than the aggregating salt or a chelating agent; a method of adjusting the pH; a method of lowering the temperature of the reaction system (dispersion liquid) during aggregation; and a method of adding a large amount of an aqueous medium to dilute the concentration of the reaction system (dispersion liquid) during aggregation. These methods may be used alone or in combination of two or more types.

The volume average particle diameter of the aggregated particles is not particularly limited and can be appropriately selected according to a purpose, but is preferably from 3.0 μm to 6.0 μm, and more preferably from 4.0 μm to 5.0 μm.

In the aggregation step, a release agent may be added, and the above-mentioned crystalline resin may be added to obtain fixability at low temperatures.

As the release agent, the release agents described above in the section <<Release Agent>> can be used.

As the crystalline resin, the crystalline resins described above in the section <<Crystalline Polyester Resin>> can be used.

When the release agent or the crystalline resin is added in the aggregation step, aggregated particles in which the release agent or the crystalline resin is uniformly dispersed can be obtained as follows. A dispersion liquid in which the release agent is dispersed in an aqueous medium is prepared or a dispersion liquid of the crystalline polyester resin C is prepared in a similar manner, and the dispersion liquid is mixed with the above-mentioned fine particle dispersion liquid (oil droplets) to aggregate the particles.

A dispersed particle diameter of the release agent in the dispersion liquid is not particularly limited and can be appropriately selected according to a purpose, but is preferably 50 nm or more and 600 nm or less, and more preferably 50 nm or more and 300 nm or less. Herein, the dispersed particle diameter of the release agent in the dispersion liquid is a volume average particle diameter.

A dispersed particle diameter of the crystalline resin in the dispersion liquid is not particularly limited and can be appropriately selected according to a purpose, but is preferably 50 nm or more and 600 nm or less, and more preferably 50 nm or more and 300 nm or less.

Herein, the dispersed particle diameter of the crystalline resin in the dispersion liquid is a volume average particle diameter.

The dispersed particle diameters of the release agent and the crystalline resin can be measured, for example, by using a NANOTRACK particle size distribution measurement device (UPA-EX150, Nikkiso Co., Ltd., dynamic light scattering method/laser Doppler method).

In a specific measurement method, a dispersion liquid in which the release agent or the crystalline resin is dispersed is adjusted to a measurement concentration range to measure the dispersed particle diameter. At this time, a background measurement is performed in advance by using only a dispersion solvent of the dispersion liquid. This measurement method makes it possible to measure sizes from several tens of nm to several μm.

### Shell Layer Forming Step

To form a shell layer on the core particles, the above-mentioned polyester water dispersion is preferably added in the aggregation step. By forming a shell layer on the core particles, the crystalline resin and the release agent that deteriorate the filming properties can be encapsulated, and thus, the filming resistance is improved.

A method of forming the shell layer is not particularly limited and can be appropriately selected according to a purpose. Examples of the method include a method in which aggregated particles are prepared by the above-described method, and then, the polyester water dispersion is added to the aggregated particles having a desired particle diameter.

When the method of manufacturing the resin particles includes the solvent removal step, the polyester water dispersion may be added after obtaining aggregated particles of the core particles obtained in the solvent removal step.

### Fusion Step

The fusion step is a step in which the aggregated particles are fused to reduce unevenness and obtain spherical resin particles. Further, in a case where a resin is added in the aggregation step to form a shell layer on the resin particles, a shell layer can be formed on the surfaces of the aggregated particles in the fusion step.

A method of fusing the aggregated particles is not particularly limited and can be appropriately selected according to a purpose. An example of the method includes a method in which a dispersion liquid of the aggregated particles is heated while being stirred.

The heating temperature is not particularly limited and can be appropriately selected according to a purpose, but is preferably equal to or higher than Tg of the amorphous polyester resin B and equal to or lower than the Tg+20° C., and more preferably equal to or higher than Tg of the amorphous polyester resin B and equal to or lower than the Tg+10° C. When the heating temperature is equal to or lower than Tg+20° C. of the amorphous polyester resin B, the amorphous polyester resin B and the crystalline polyester resin C have appropriate compatibility with each other, and the heat-resistant storage stability is improved.

The average circularity of the resin particles is not particularly limited and can be appropriately selected according to a purpose. However, if the average circularity of the resin particles is higher, the resin particles rotate smoothly in the development nip when the resin particles are used as a toner, and thus, more resin particles can be transferred to an electrostatic latent image bearer. Therefore, the average circularity is preferably 0.95 or higher, and more preferably 0.96 or higher.

### Measurement of Average Circularity

In the present embodiment, the average particle diameter and the average circularity can be measured by using a flow-type particle image analyzer (FPIA-3000, manufactured by Sysmex Corporation), for example.

In a specific measurement method, 100 mL to 150 mL of water from which solid impurities are removed in advance is filled into a container. 0.1 mL to 0.5 mL of a surfactant, preferably an alkylbenzene sulfonate salt, is added as a dispersant to the container, and then, about 0.1 g to 0.5 g of the measurement sample is added. The suspension liquid in which the sample is dispersed is subjected to a dispersion treatment for about 1 to 3 minutes by using an ultrasonic disperser. The average particle diameter, the average circularity, and the standard deviation (SD) of the circularity are measured at a dispersion liquid concentration of 3,000 particles/μL to 10,000 particles/μL by using the above-mentioned device.

The equivalent circle diameter is defined as the particle diameter, and the average particle diameter is determined based on the equivalent circle diameter (number basis), and the analysis conditions in the flow-type particle image analyzer are listed below.

### Analysis Conditions

Particle diameter limits: 0.5 μm≤equivalent circle diameter (number-based)≤200.0 μm
Particle shape limits: 0.93<circularity≤1.00

In the present embodiment, the average circularity is defined as follows.

(Average circularity)=(circumference of a circle equal to projected area of particle)/(circumference of projected image of particle)

### Washing Step

The washing step is a step of washing the resin particles obtained in the aggregation step or the fusion step.

The dispersion liquid of the resin particles obtained by the above-mentioned method may contain, in addition to the resin particles, an auxiliary material such as an aggregating agent. Therefore, it is preferable to wash the dispersion liquid of the resin particles to extract only the resin particles from the dispersion liquid of the resin particles.

A method of washing the resin particles is not particularly limited and can be appropriately selected according to a purpose. Examples of the method include a centrifugation method, a filtration method under reduced pressure, and a filter press method.

All of the above-mentioned washing methods produce a cake body of the resin particles. If it is not possible to sufficiently wash the resin particles in one operation, the obtained cake body may be dispersed again in an aqueous solvent to form a slurry, and the process of extracting the resin particles by at least any one of the above-mentioned washing methods may be repeated.

When the filtration method under reduced pressure or the filter press method are used to wash the resin particles, a method may be adopted in which an aqueous solvent is passed through the cake body to remove the auxiliary material held by the resin particles.

The aqueous solvent used in the washing step is not particularly limited and can be appropriately selected according to a purpose. Examples of the aqueous solvent include, but are not limited to, water and a mixed solvent of water and alcohol.

Examples of the alcohol include, but are not limited to, methanol and ethanol.

Among these solvents, the aqueous solvent is preferably water from the viewpoints of cost and environmental impact due to wastewater treatment.

### Drying Step

The drying step is a step of washing the resin particles obtained in the washing step.

The resin particles washed in the washing step contain a large amount of the aqueous medium, and thus, the aqueous medium may be removed by drying in the drying step to obtain only the resin particles.

The drying method is not particularly limited and can be appropriately selected according to a purpose. Examples of the drying method include a method of using a drying device such as a spray dryer, a vacuum freeze dryer, a reduced pressure dryer, a stationary shelf dryer, a movable shelf dryer, a fluidized bed dryer, a rotary dryer, and a stirring-type dryer.

The final moisture content of the dried resin particles is not particularly limited and can be appropriately selected according to a purpose, but the moisture content is preferably less than 1 mass %.

The resin particles dried in the drying step are in the form of soft agglomerates. If the soft agglomerates are inconvenient for use, the resin particles may be crushed to break up the soft agglomerates.

A method for crushing the resin particles is not particularly limited and can be appropriately selected according to a purpose. Examples of the method include a method of using a device such as a jet mill, a Henschel mixer, a SUPER MIXER, a coffee mill, an OSTER blender, and a food processor.

### Classification Step

The classification step is a step of classifying the resin particles obtained in the washing step or the drying step.

A method of classifying the resin particles is not particularly limited and can be appropriately selected according to a purpose. Examples of the method include a method in which fine particle portions in a liquid are removed by using a cyclone, a decanter, centrifugation, or the like; and a method in which a known classification operation is implemented after drying.

### Annealing Step

The annealing step is a step that is implemented after the drying step when a crystalline resin is added. In the annealing step, the crystalline resin and the amorphous polyester resin are phase-separated.

A method of performing the annealing treatment is not particularly limited and can be appropriately selected according to a purpose. Examples of the method include a method in which the resin is stored at a temperature close to the glass transition temperature (Tg) of the crystalline resin for 10 hours or longer.

In the fusion step, when the resin is heated close to a temperature exceeding the glass transition temperature (Tg) of the resin being used, the crystalline resin and the amorphous polyester resin are compatible, and thus, it may not be possible to achieve both heat-resistant storage stability and fixability at low temperatures. However, when the annealing treatment is performed, phase separation between the crystalline resin and the amorphous resin proceeds, which is advantageous in that the crystalline resin and the amorphous resin are no longer compatible with each other.

### Toner

The toner of the present disclosure contains toner resin particles of the present disclosure, and preferably further contains an external additive, and if desired, further contains other components.

### Toner Resin Particles

The characteristics of the resin particles included in the toner resin particles are described above in the section (Toner Resin Particles), and the details thereof are omitted.

In the toner, the toner resin particles serve as toner base particles.

The content of the toner resin particles in the toner is not particularly limited and can be appropriately selected according to a purpose. The toner may serve as the toner resin particles.

### External Additives

The external additives are not particularly limited and can be appropriately selected according to a purpose. Examples of the external additives include, but are not limited to, inorganic fine particles, fine oxide particles, fatty acid metal salts, and additives obtained by a hydrophobizing treatment of these external additives. These external additives may be used alone or in combination of two or more types.

The average particle diameter of primary particles in the inorganic fine particles is not particularly limited and can be appropriately selected according to a purpose. However, the average particle diameter is preferably 100 nm or less, more preferably 1 nm or more and 100 nm or less, even more preferably 3 nm or more and 70 nm or less, and particularly preferably 5 nm or more and 70 nm or less. When the average particle diameter of the primary particles of the inorganic fine particles is 1 nm or more, the inorganic fine particles do not embed into the toner and function effectively. When the average particle diameter is 100 nm or less, uneven damage to the surface of the photoconductor can be suppressed.

The inorganic fine particles preferably contain at least one type of inorganic fine particles in which the average particle diameter of the primary particles is 20 nm or less, and at least one type of inorganic fine particles in which the average particle diameter of the primary particles is 30 nm or more.

The specific surface area of the inorganic fine particles obtained by the BET method is not particularly limited and can be appropriately selected according to a purpose, but is preferably 20 m²/g or more and 500 m²/g or less.

The inorganic fine particles are not particularly limited and can be appropriately selected according to a purpose. Examples of the inorganic fine particles include, but are not limited to, silica, alumina, titanium oxide, barium titanate, magnesium titanate, calcium titanate, strontium titanate, iron oxide, copper oxide, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. These inorganic fine particles may be used alone or in combination of two or more types. Among these inorganic fine particles, silica and titanium dioxide are preferred.

The fine oxide particles are not particularly limited and can be appropriately selected according to a purpose. Examples of the fine oxide particles include, but are not limited to, titania, alumina, tin oxide, and antimony oxide.

Examples of the fatty acid metal salts include, but are not limited to, zinc stearate and aluminum stearate.

Among these external additives, the external additive is preferably silica, titania, titanium oxide, or fine alumina particles, which are subjected to a hydrophobizing treatment.

Examples of the fine silica particles include, but are not limited to, R972, R974, RX200, RY200, R202, R805, and R812 (all manufactured by Nippon Aerosil Co., Ltd.).

Examples of the fine titania particles include, but are not limited to, P-25 (manufactured by Nippon Aerosil Co., Ltd.), STT-30, STT-65C-S (both manufactured by Titan Kogyo, Ltd.), TAF-140 (manufactured by Fuji Titanium Industry Co., Ltd.), MT-150W, MT-500B, MT-600B, and MT-150A (all manufactured by TAYCA, Co., Ltd.).

Examples of the fine titanium oxide particles obtained in the hydrophobizing treatment include, but are not limited to, T-805 (manufactured by Nippon Aerosil Co., Ltd.), STT-30A, STT-65S-S (both manufactured by Titan Kogyo, Ltd.), TAF-500T, TAF-1500T (both manufactured by Fuji Titanium Industry Co., Ltd.), MT-100S, MT-100T (all manufactured by TAYCA, Co., Ltd.), and IT-S (manufactured by Ishihara Sangyo Kaisha, Ltd.).

For example, the fine oxide particles obtained in the hydrophobizing treatment, the fine silica particles obtained in the hydrophobizing treatment, the fine titania particles obtained in the hydrophobizing treatment, and the fine alumina particles obtained in the hydrophobizing treatment can be obtained by treating hydrophilic fine particles with a silane coupling agent such as methyltrimethoxysilane, methyltriethoxysilane, and octyltrimethoxysilane. If silicone oil is desirably used, inorganic fine particles and fine oxide particles treated with silicone oil obtained by heating inorganic fine particles can also be suitably used. The surface of the external additive may be treated with the above-mentioned fluidity improvers.

The silicone oil is not particularly limited and can be appropriately selected according to a purpose. Examples of the silicone oil include, but are not limited to, dimethyl silicone oil, methylphenyl silicone oil, chlorophenyl silicone oil, methylhydrogen silicone oil, alkyl-modified silicone oil, fluorine-modified silicone oil, polyether-modified silicone oil, alcohol-modified silicone oil, amino-modified silicone oil, epoxy-modified silicone oil, epoxy/polyether-modified silicone oil, phenol-modified silicone oil, carboxyl-modified silicone oil, mercapto-modified silicone oil, methacryl-modified silicone oil, and α-methylstyrene-modified silicone oil.

The content of the external additive is not particularly limited and can be appropriately selected according to a purpose, but is preferably 0.1 parts by mass or more and 5 parts by mass or less, and more preferably 0.3 parts by mass or more and 3 parts by mass or less, with respect to 100 parts by mass of the toner.

A method of manufacturing the toner is not particularly limited and can be appropriately selected from known methods. However, the toner is preferably manufactured by the method of manufacturing toner of the present disclosure described below.

### Method of Manufacturing Toner

The method of manufacturing toner of the present disclosure includes a mixing step of mixing the toner resin particles of the present disclosure with an external additive, and further includes other steps, if desired.

The characteristics of the toner resin particles are described above in the section (Toner Resin Particles), and the characteristics of the external additives are described above in the portion <External Additives> of the section (Toner), and thus, details thereof will be omitted.

### Mixing Step

The mixing step is a step of mixing the toner resin particles serving as the toner base particles with the external additive. At this time, it is preferable to apply a mechanical impact force, because in this case, the particles of the external additive can be prevented from detaching from the surface of the toner base particles.

A method of applying the mechanical impact force is not particularly limited and can be appropriately selected according to a purpose. Examples of the method include a method of applying an impact force to the mixture of the toner resin particles and the external additive by using a blade rotating at high speed; and a method of introducing a mixture of the toner resin particles and the external additive into a high-speed air stream and accelerating the mixture to cause particles to collide with each other or against an appropriate collision plate.

A device used in the method of applying the mechanical impact force is not particularly limited and can be appropriately selected according to a purpose. Examples of the device include, but are not limited to, ANGMILL (manufactured by Hosokawa Micron Corporation), a device obtained by modifying an I-type mill (manufactured by Nippon Pneumatic Mfg. Co., Ltd.) to reduce the pulverizing air pressure, a HYBRIDIZATION SYSTEM (manufactured by Nara Machinery, Co., Ltd.), a KRYPTRON SYSTEM (manufactured by Kawasaki Heavy Industries, Ltd.), and an automatic mortar.

### Other Components

The other components are not particularly limited and can be appropriately selected as desired. Examples of the other components include, but are not limited to, foam inhibitors (antifoaming agents), pH adjusters, preservatives/fungicides, chelating agents, rust inhibitors, antioxidants, ultraviolet absorbers, oxygen absorbers, and light stabilizers. These components may be used alone or in combination of two or more types.

The content of the other components in the ink is not particularly limited and can be appropriately selected according to a purpose, as long as the effect of the present disclosure is not impaired.

### Developer

The developer of the present disclosure contains at least the toner of the present disclosure, and if desired, further contains appropriately selected other components such as a carrier.

The toner contained in the developer of the present disclosure contains the toner resin particles of the present disclosure, and thus, the developer has high environmental compatibility, carbon neutrality, and excellent heat-resistant storage stability. Therefore, the developer has excellent transferability, chargeability, and the like, and can stably form images of high quality.

The developer may be a one-component developer or a two-component developer. However, when used in a high-speed printer and the like responding to the increased information processing speed in recent years, a two-component developer is preferred, because such a developer provides a longer service life.

When the developer is used as a one-component developer, and even if the toner is being consumed and resupplied, the particle diameter of the toner varies little, there is little filming of the toner on the developing roller, and the toner hardly fuses with components such as a blade used to obtain a thin layer of the toner. Therefore, it is possible to obtain good and stable developing properties and images, even when the developer is stirred during a long period of time in the developing device.

When the developer is used as a two-component developer, the particle diameter of the toner varies little, even when the toner is being consumed and resupplied over a long period of time. Therefore, good and stable developing properties and images can be obtained, even when the toner is stirred during a long period of time in the developing device.

### Carrier

The carrier is not particularly limited and can be appropriately selected according to a purpose. However, the carrier preferably includes a core material and a resin layer covering the core material.

### Core Material

The material of the core material is not particularly limited and can be appropriately selected according to a purpose. Examples of the material include, but are not limited to, manganese-strontium based materials having a magnetization of 50 emu/g to 90 emu/g and manganese-magnesium based materials of 50 emu/g to 90 emu/g. To ensure image density, it is preferable to use a highly magnetized material such as iron powder of 100 emu/g or more and magnetite of 75 emu/g to 120 emu/g.

Further, it is preferable to use a weakly magnetized material such as a copper-zinc material having a magnetization of 30 emu/g to 80 emu/g, because in this case, it is possible to alleviate the impact of developer in an upright state on the photoconductor, which is advantageous for obtaining high image quality.

These materials may be used alone or in combination of two or more types.

The volume average particle diameter of the core material is not particularly limited and can be appropriately selected according to a purpose, but is preferably 10 μm or more and 150 μm or less, and more preferably 40 μm or more and 100 μm or less. When the volume average particle diameter of the core material is 10 μm or more, it is possible to prevent an increase of fine powder in the carrier, and to suppress scattering of the carrier due to a decrease in the magnetization per particle. When the volume average particle diameter of the core material is 150 μm or less, it is possible to prevent a decrease in the specific surface area, suppress scattering of the toner, and in particular, in a full color system having a large number of solid portions, it is possible to prevent a deterioration of the reproduction of the solid portions.

When the toner is used in a two-component developer, the toner may be mixed with the carrier and used as a mixture. The content of the carrier in the two-component developer is not particularly limited and can be appropriately selected according to a purpose. However, the content is preferably 90 parts by mass or more and 98 parts by mass or less, and more preferably 93 parts by mass or more and 97 parts by mass or less, with respect to 100 parts by mass of the two-component developer.

The developer can be suitably used to form images by various types of known electrophotographic methods such as a magnetic one-component development method, a non-magnetic one-component development method, and a two-component development method.

As a development method, a premix development method may be adopted in which a premix developer in which the toner and carrier are mixed in advance is replenished. In the premix development method, a portion corresponding to an amount by which the carrier increases in the developing device is discharged as surplus developer. This gradually refreshes the developer in the developing device. Therefore, it is possible to extend the replacement cycle of the developer due to deterioration, and to eliminate the burden of replacing the developer.

### Image Forming Apparatus and Image Forming Method

The image forming apparatus of the present disclosure includes an electrostatic latent image bearer, an electrostatic latent image forming device used for forming an electrostatic latent image on the electrostatic latent image bearer, and a developing device containing a toner used for developing the electrostatic latent image formed on the electrostatic latent image bearer to form a visible image, and may further include other devices, if desired. The toner in the developing device is the toner of the present disclosure.

The image forming method of the present disclosure includes an electrostatic latent image forming step of forming an electrostatic latent image on an electrostatic latent image bearer, and a developing step of developing the electrostatic latent image formed on the electrostatic latent image bearer with a toner to form a visible image, and may further include other steps, if desired. The toner in the developing step is the toner of the present disclosure.

The image forming method can be suitably performed by the image forming apparatus. The electrostatic latent image forming step can be suitably performed by the electrostatic latent image forming device. The developing step can be suitably performed by the developing device. The other steps can be suitably performed by the other devices.

### Electrostatic Latent Image Bearer

The structure, the size, and the like of the electrostatic latent image bearer are not particularly limited and can be appropriately selected from known electrostatic latent image bearers. The shape of the electrostatic latent image bearer is not particularly limited and can be appropriately selected according to a purpose. For example, the electrostatic latent image bearer may have the shape of a drum or a belt. A material of the electrostatic latent image bearer is not particularly limited and can be appropriately selected according to a purpose. Examples of the material include, but are not limited to, an inorganic photoconductor such as amorphous silicon and selenium, and an organic photoconductor (OPC) such as polysilane and phthalopolymethine.

Examples of the organic photoconductor include, but are not limited to, a laminated photoconductor and a single-layer photoconductor. The laminated photoconductor has a laminated structure in which, on a support body such as an aluminum drum, a layer in which a charge generation material such as metal-free phthalocyanine or titanyl phthalocyanine is dispersed in a binder resin (charge generation layer), and a layer in which a charge transport material is dispersed in a binder resin (charge transport layer) are stacked. The single-layer photoconductor includes a photosensitive layer having a single layer structure in which both a charge generation material and a charge transport material are dispersed in a binder resin on a support body.

If a single-layer photoconductor is used, a hole transport agent and an electron transport agent may be added to the photosensitive layer as charge transport materials.

Further, an undercoat layer may be provided between the support body and the charge generation layer in the laminated photoconductor or between the support body and the photosensitive layer in the single-layer photoconductor.

The shape of the electrostatic latent image bearer is not particularly limited and can be appropriately selected according to a purpose, but a cylindrical shape is preferred.

The outer diameter of the electrostatic latent image bearer having the above-mentioned cylindrical shape is not particularly limited and can be appropriately selected according to a purpose. However, the outer diameter is preferably 3 mm or more and 100 mm or less, more preferably 5 mm or more and 50 mm or less, and particularly preferably 10 mm or more and 30 mm or less.

### Electrostatic Latent Image Forming Device and Electrostatic Latent Image Forming Step

The electrostatic latent image forming device is a device used for forming an electrostatic latent image on the electrostatic latent image bearer.

The electrostatic latent image forming step is a step of forming an electrostatic latent image on the electrostatic latent image bearer.

The electrostatic latent image forming step is suitably performed by the electrostatic latent image forming device.

The electrostatic latent image forming device is not particularly limited and can be appropriately selected according to a purpose. Examples of the electrostatic latent image forming device include a device including at least a charging member that charges the surface of the electrostatic latent image bearer, and an exposure member that exposes the surface of the electrostatic latent image bearer to light in the form of an image.

The electrostatic latent image forming step is not particularly limited and can be appropriately selected according to a purpose. For example, the electrostatic latent image forming step can be performed by charging the surface of the electrostatic latent image bearer and then exposing the surface to light in the form of an image.

### Charging Member and Charging Process

The charging member is not particularly limited and can be appropriately selected from known charging members according to a purpose. Examples of the charging member include a contact charger, and a non-contact charger that utilizes corona discharge such as a corotron and a scorotron.

The contact charger preferably includes a roller, a brush, a film, a rubber blade, or the like, which are conductive or semiconductive.

The charging process can be implemented, for example, by using the charging member to apply a voltage to the surface of the electrostatic latent image bearer.

The charging member may have the shape of a roller, a magnetic brush, a fur brush, or the like, and can be selected according to the specifications and aspects of the image forming apparatus.

The charging member is not limited to the contact-type charging member, but it is preferable to use a contact-type charging member, because in this case, it is possible to obtain an image forming apparatus in which the amount of ozone generated from the charging member is reduced.

### Exposure Member and Exposure Process

The exposure member is not particularly limited and can be appropriately selected according to a purpose, as long as the exposure member can expose, in the form of the image to be formed, the surface of the electrostatic latent image bearer charged by the charging member. Examples of the exposure member include various types of exposure members such as copying optical systems, rod lens array systems, laser optical systems, and liquid crystal shutter optical systems.

The light source used in the exposure member is not particularly limited and can be appropriately selected according to a purpose. Examples of the light source include, but are not limited to, general light-emitting devices such as fluorescent lamps, tungsten lamps, halogen lamps, mercury lamps, sodium lamps, light-emitting diodes (LEDs), semiconductor lasers (LDs), and electroluminescence (EL) sources.

To emit light in a desired wavelength region, various types of filters can be used, such as a sharp cut filter, a band pass filter, a near infrared cut filter, a dichroic filter, an interference filter, and a color temperature conversion filter.

The exposure process can be implemented, for example, by using the above-described exposure member to expose the surface of the electrostatic latent image bearer in the form of an image.

In the present embodiment, a back-light method may be adopted in which the electrostatic latent image bearer is exposed to light in the form of an image from the back side.

### Developing Device and Developing Step

The developing device is a device including a toner that develops the electrostatic latent image formed on the electrostatic latent image bearer to form a visible image.

The developing step is a step of developing the electrostatic latent image formed on the electrostatic latent image bearer with a toner to form a visible image.

The developing step is suitably performed by the developing device.

The developing device is not particularly limited and can be appropriately selected according to a purpose. Examples of the developing device include a developing device using a dry development method or a developing device using a wet development method. Further, the developing device may be a monochrome developing device or a multicolor developing device. Among these developing devices, the developing device is preferably a developing device including a stirring device that frictionally stirs the toner to charge the toner, and a rotatable developer bearer including a magnetic field generating means fixed on the inside and carrying a developer including the toner on a surface.

For example, in the developing device, the toner and the carrier are mixed and stirred, and at this time, the toner is charged by friction, and is maintained in an upright state on the surface of a rotating magnet roller, to form a magnetic brush. The magnet roller is arranged in the vicinity of the electrostatic latent image bearer. Therefore, a part of the toner forming the magnetic brush formed on the surface of the magnet roller moves to the surface of the electrostatic latent image bearer by electric attraction. As a result, the electrostatic latent image is developed by the toner, and a visible image is formed by the toner on the surface of the electrostatic latent image bearer.

The type of the carrier is not particularly limited and can be appropriately selected according to a purpose. For example, the carriers described above in the section (Developer) can be used.

### Other Devices and Other Steps

The other devices are not particularly limited and can be appropriately selected according to a purpose. Examples of the other devices include, but are not limited to, transfer device, fixing device, cleaning device, static elimination device, recycling device, and control device.

The other steps are not particularly limited and can be appropriately selected according to a purpose. Examples of the other steps include a transfer step, a fixing step, a cleaning step, a static elimination step, a recycling step, and a control step.

### Transfer Device and Transfer Step

The transfer device is a device that transfers the visible image formed by the developing device onto a recording medium.

The transfer step is a step of transferring the visible image formed in the development step onto a recording medium.

The transfer step is suitably performed by the transfer device.

The transfer device is not particularly limited and can be appropriately selected according to a purpose. However, in a preferred embodiment, the transfer device includes a primary transfer device that transfers the visible image onto an intermediate transfer body to form a composite transfer image, and a secondary transfer device that transfers the composite transfer image onto a recording medium.

The transfer step is not particularly limited and can be appropriately selected according to a purpose. However, in a preferred embodiment of the transfer step, an intermediate transfer body is used to transfer the visible image onto the intermediate transfer body by primary transfer, and then, transfer the visible image onto the recording medium by secondary transfer. Specifically, the transfer step may be performed by charging the visible image onto the photoconductor by using a transfer charger, for example. The transfer step may be performed by the transfer device.

Here, when an image to be transferred by secondary transfer onto the recording medium is a color image including toners of a plurality of colors, a configuration may be such that the transfer device sequentially superimposes toners of each color on the intermediate transfer body to form an image on the intermediate transfer body, and the intermediate transfer device transfers the image on the intermediate transfer body by secondary transfer onto the recording medium in one process.

The intermediate transfer body is not particularly limited and can be appropriately selected from known transfer bodies according to a purpose. Preferred examples of the intermediate transfer body include, but are not limited to, a transfer belt.

The transfer device (the primary transfer device and the secondary transfer device) preferably includes at least a transfer device that peels and charges the visible image formed on the photoconductor toward the recording medium.

The transfer device is not particularly limited and can be appropriately selected according to a purpose. Examples of the transfer device include, but are not limited to, a corona transfer device using corona discharge, a transfer belt, a transfer roller, a pressure transfer roller, and an adhesive transfer device.

A typical example of the recording medium is plain paper. However, the recording medium is not particularly limited and can be appropriately selected according to a purpose, as long as the recording medium can receive an unfixed image after development. For example, a PET base for overhead projectors (OHP) can also be used.

### Fixing Device and Fixing Step

The fixing device is a device that fixes the transferred image transferred onto the recording medium.

The fixing step is a step of fixing the transferred image transferred onto the recording medium.

The fixing step is suitably performed by the fixing device.

The fixing device is not particularly limited and can be appropriately selected according to a purpose, but is preferably a known heating and pressing member.

The heating and pressing member is not particularly limited and can be appropriately selected according to a purpose. Examples of the heating and pressing member include a combination of a heating roller and a pressure roller, and a combination of a heating roller, a pressure roller, and an endless belt.

Note that, in the present disclosure, according to a purpose, a known optical fixing device may be used together with or instead of the fixing device, for example.

The fixing step is not particularly limited and can be appropriately selected according to a purpose. For example, the fixing step may be performed every time toner of each color is transferred onto the recording medium, or simultaneously at once after the toners of each color are superimposed.

The heating temperature in the heating and pressing member is not particularly limited and can be appropriately selected according to a purpose, but is preferably 80° C. or higher and 200° C. or lower.

The surface pressure in the fixing step is not particularly limited and can be appropriately selected according to a purpose, but is preferably 10 N/cm² or more and 80 N/cm² or less.

### Cleaning Device and Cleaning Step

The cleaning device is a device used for removing the toner remaining on the photoconductor.

The cleaning step is a step of removing the toner remaining on the photoconductor.

The cleaning step is suitably performed by the cleaning device.

The cleaning device is not particularly limited and can be appropriately selected according to a purpose. Examples of the cleaning device include, but are not limited to, a magnetic brush cleaner, an electrostatic brush cleaner, a magnetic roller cleaner, a blade cleaner, a brush cleaner, and a web cleaner.

### Recycling Device and Recycling Step

The recycling device is a device that conveys the toner removed by the cleaning device to the developing device and recycles the toner.

The recycling step is a step of conveying the toner removed in the cleaning step to the developing device and recycling the toner.

The recycling step is suitably performed by the recycling device.

The recycling device is not particularly limited and can be appropriately selected according to a purpose. Examples of the recycling device include known conveyers.

### Control Device and Control Step

The control device is a device that controls an operation of each of the means.

The control step is a step of controlling an operation in each of the steps.

The control step is suitably performed by the control device.

The control device is not particularly limited and can be appropriately selected according to a purpose. Examples of the control device include devices such as a sequencer and a computer.

### Image Forming Apparatus

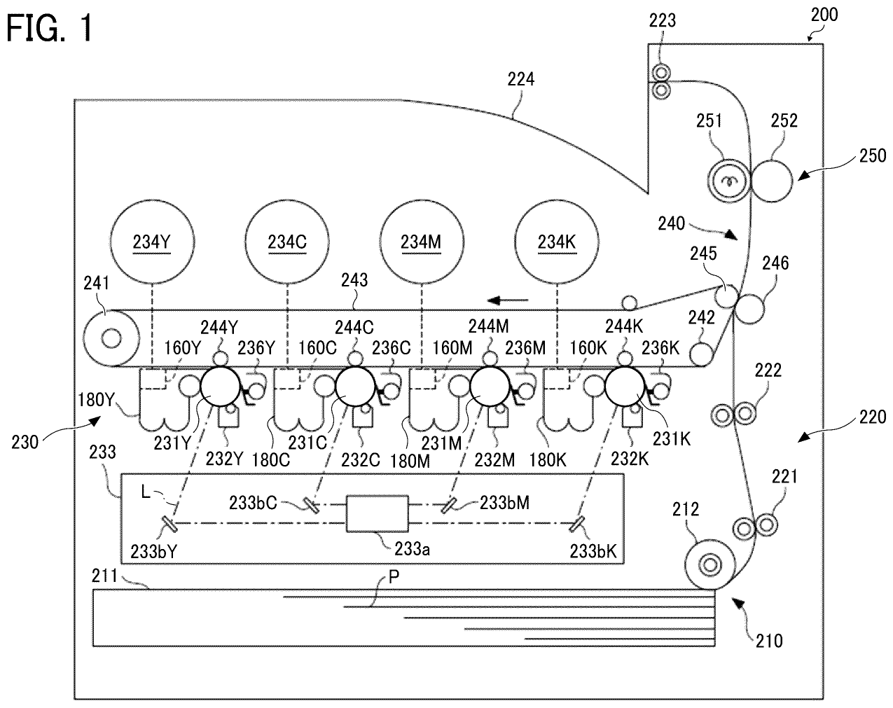

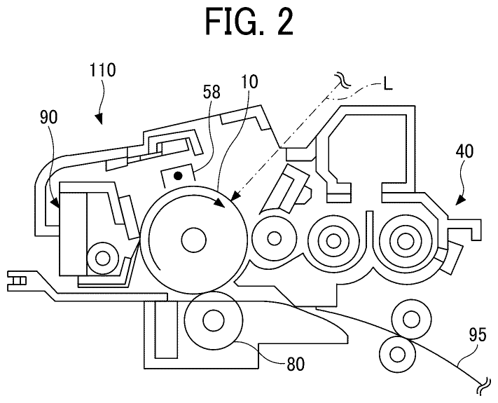

Next, an embodiment of the image forming apparatus of the present disclosure and the image forming method of the present disclosure will be described with reference to FIGS. 1 and 2.

Although a printer is described as an example of the image forming apparatus in the present embodiment, the image forming apparatus is not particularly limited, as long as the image forming apparatus can form an image by using toner, such as a copier, a facsimile, and a multifunction peripheral.

An image forming apparatus 200 includes a sheet feeder 210, a conveyer 220, an image formation device 230, a transfer device 240, and a fixing device 250.

The sheet feeder 210 includes a sheet feeding cassette 211 in which a sheet P to be fed is stacked, and a sheet feeding roller 212 that feeds the sheet P stacked in the sheet feeding cassette 211 one sheet at a time. The conveyer 220 includes a roller 221 that conveys the sheet P fed by the sheet feeding roller 212 toward the transfer device 240, a pair of timing rollers 222 that hold a tip portion of the sheet P conveyed by the roller 221 and wait to convey the sheet P to the transfer device 240 at a predetermined timing, and a sheet ejection roller 223 that ejects the sheet P with the color toner image fixed thereto onto a sheet ejection tray 224.

The image formation device 230 includes: spaced at a predetermined interval from left to right in FIG. 1, an image forming unit 180Y that forms an image by using a developer containing yellow toner, an image forming unit 180C that uses a developer containing cyan toner, an image forming unit 180M that uses a developer containing magenta toner, and an image forming unit 180K that uses a developer containing black toner; sub-hoppers 160Y, 160C, 160M, and 160K; chargers 232Y, 232C, 232M, and 232K; toner bottles 234Y, 234C, 234M, and 234K; and an exposure device 233. The exposure device 233 includes a light source 233a and polygon mirrors 233bY, 233bC, 233bM, and 233bK.

Note that, when referring to any image forming unit among the image forming units 180Y, 180C, 180M, and 180K, the term “image forming unit 180” is used.

The developer contains a toner and a carrier. The four image forming units 180Y, 180C, 180M, and 180K have substantially the same mechanical configuration, except that the developer used in each of the image forming units is different.

As a development method, a premix development method may be adopted in which a premix developer in which toner and carrier are mixed in advance is replenished. In the premix development method, a portion corresponding to an amount by which the carrier increases in the developing device is discharged as surplus developer. This gradually refreshes the developer in the developing device. Therefore, it is possible to extend the replacement cycle of the developer due to deterioration, and to eliminate the burden of replacing the developer.

The transfer device 240 includes a drive roller 241 and a driven roller 242, an intermediate transfer belt 243 that can rotate counterclockwise in FIG. 1 as the drive roller 241 is driven, primary transfer rollers 244Y, 244C, 244M, and 244K arranged to face respective photoconductors 231Y, 231C, 231M, and 231K across the intermediate transfer belt 243, and a secondary counter roller 245 and a secondary transfer roller 246 arranged to face each other across the intermediate transfer belt 243 at a transfer position where the toner image is transferred to the sheet. Further, cleaning devices 236Y, 236C, 236M, and 236K are provided to remove residual toner remaining on the surfaces of the respective photoconductors 231Y, 231C, 231M, and 231K after transfer.

Here, the structure, the size, and the like of the photoconductors 231Y, 231C, 231M, and 231K are not particularly limited and can be appropriately selected from known photoconductors. The shape of the electrostatic latent image bearer is not particularly limited and can be appropriately selected according to a purpose. For example, the image bearer may have the shape of a drum or a belt. The material of the photoconductor is not particularly limited and can be appropriately selected according to a purpose. Examples of the material include, but are not limited to, inorganic photoconductors such as amorphous silicon and selenium, and organic photoconductors (OPC) such as polysilane and phthalopolymethine.

Examples of the organic photoconductor include, but are not limited to, a laminated photoconductor and a single-layer photoconductor. The laminated photoconductor has a laminated structure in which, on a support body such as an aluminum drum, a layer in which a charge generation material such as metal-free phthalocyanine, titanyl phthalocyanine, and gallium phthalocyanine is dispersed in a binder resin (charge generation layer), and a layer in which a charge transport material is dispersed in a binder resin (charge transport layer) are stacked. The single-layer photoconductor includes a photosensitive layer having a single layer structure in which both a charge generation material and a charge transport material are dispersed in a binder resin on a support body.

If a single-layer photoconductor is used, a hole transport agent and an electron transport agent may be added to the photosensitive layer as charge transport materials.

Further, an undercoat layer may be provided between the support body and the charge generation layer in the laminated photoconductor or between the support body and the photosensitive layer in the single-layer photoconductor.

In the present embodiment, an elastic intermediate transfer belt may be used as the intermediate transfer belt 243. For example, an intermediate transfer belt obtained by laminating a flexible elastic layer on a rigid base layer that provides a relatively flexible property may be used as the elastic intermediate transfer belt.

To prevent the intermediate transfer belt 243 from meandering, a guide member that prevents deviation may be provided on an inner peripheral surface of the intermediate transfer belt 243.

The fixing device 250 includes a fixing belt 251 including a heater therein to heat the sheet P, and a pressure roller 252 that rotatably applies a pressure to the fixing belt 251 to form a nip. Thus, heat and pressure are applied to the color toner image on the sheet P, and the color toner image is fixed. The sheet P on which the color toner image is fixed is ejected onto a sheet ejection tray 224 by a sheet ejection roller 223, and thus, a series of image forming processes is completed.

### Toner Storage Unit

The toner storage unit of the present disclosure refers to a portion that stores toner in a unit having a function of storing toner.

The toner contained in the toner storage unit is the toner of the present disclosure. Therefore, the toner storage unit of the present disclosure has high environmental compatibility. Further, by attaching the toner storage unit to the image forming apparatus of the present disclosure and forming an image, the image is formed by using the toner of the present disclosure. Therefore, high carbon neutrality and excellent heat-resistant storage stability are achieved.

The aspects of the toner storage unit are not particularly limited and can be appropriately selected according to a purpose, as long as the toner storage unit can store the toner. Examples of the toner storage unit include a toner storage container, a developing unit, and a process cartridge.

### Toner Storage Container

The toner storage container refers to a container storing the toner.

The toner storage container is not particularly limited and can be appropriately selected from known containers. For example, the toner storage container may have a container main body and a cap.

The size of the container main body is not particularly limited and can be appropriately changed.

The shape of the container main body is not particularly limited and can be appropriately changed, but is preferably tubular.

The structure of the container main body is not particularly limited and can be appropriately changed. However, the structure is preferably a structure in which a spiral-shaped irregularity is formed on an inner peripheral surface, and the toner that represents the content material can be moved to a discharge outlet by rotating the container main body, and a part of or the entire spiral-shaped irregularity has a bellows function.

The material of the container main body is not particularly limited and can be appropriately changed. However, it is preferable that the material has good dimensional accuracy, and examples of the material include, but are not limited to, resin materials such as polyester resin, polyethylene resin, polypropylene resin, polystyrene resin, polyvinyl chloride resin, polyacrylic acid, polycarbonate resin, ABS resin, and polyacetal resin. These resins may be used alone or in combination of two or more types.

The toner storage container can be easily stored and transported, and has excellent handleability. Therefore, the toner storage container can be attached to and detached from a process cartridge or an image forming apparatus and used for replenishing the toner.

### Developing Unit

The developing unit refers to a device that stores the toner and includes a developing device.

The developing device is not particularly limited and can be appropriately selected according to a purpose. For example, the developing device includes at least the toner storage container and a toner bearer that carries and conveys the toner stored in the toner storage container.

The developing device may further include a regulating member that regulates the thickness of the toner carried by the developing device.

### Process Cartridge

The above-mentioned process cartridge refers to a cartridge that stores the toner, is attachable to and detachable from an image forming apparatus, and in which at least an electrostatic latent image bearer and a developing device are integrally formed. The process cartridge may further include at least one component selected from a charging device, an exposure device, a cleaning device, and a static elimination device, if desired.

An example of the process cartridge is a process cartridge that is molded to be attachable to and detachable from various types of image forming apparatuses, and includes at least an electrostatic latent image bearer that carries an electrostatic latent image, and a developing device that develops the electrostatic latent image carried on the electrostatic latent image bearer by using the toner to form a toner image, and the process cartridge may further include other devices, if desired.

Next, one embodiment of the process cartridge is illustrated in FIG. 2. As illustrated in FIG. 2, a process cartridge 110 of the present embodiment houses an electrostatic latent image bearer 10 therein, and includes a charger 58 as a charging device, a developing device 40 as a developing device, and a cleaning device 90 as a cleaning device, and if desired, further includes other devices. In FIG. 2, reference sign L indicates exposure from an exposure device, and reference sign 95 indicates a recording sheet.

As the electrostatic latent image bearer 10, an electrostatic latent image bearer similar to the one in the image forming apparatus can be used. Any charging member may be used as the charger 58.

In an image forming process by the process cartridge illustrated in FIG. 2, while the electrostatic latent image bearer 10 rotates in the direction of an arrow, the charger 58 charges the electrostatic latent image bearer 10 and the exposure device exposes the electrostatic latent image bearer 10 to exposure light L, and thus, an electrostatic latent image corresponding to the exposed image is formed on the surface of the electrostatic latent image bearer 10.

This electrostatic latent image is developed with toner by the developing device 40, and the image developed by the toner is transferred onto the recording sheet 95 by a transfer roller 80 to be printed out. Next, the surface of the electrostatic latent image bearer 10 after the image transfer is cleaned by the cleaning device 90, and further, the charge is removed by the static elimination device, and the above-described operations are repeated again.

### EXAMPLES

The present disclosure will be described in more detail below with reference to Manufacturing Examples, Examples, and Comparative Examples. However, the present disclosure is not limited to these Manufacturing Examples, Preparation Examples, and Examples. In the Manufacturing Examples, Examples, and Comparative Examples, “%” refers to “mass %” and “parts” refers to “parts by mass”, unless otherwise specified. Blending amounts in the Examples and the Comparative Examples indicate blending amounts of solid content in each raw material.

### Manufacturing Example A-1: Synthesis of Amorphous Polyester Resin A-1

A four-neck flask was equipped with a nitrogen inlet tube, a dehydration tube, a stirrer, and a thermocouple. 152 parts of plant-derived 1,3-propanediol (manufactured by Dupont), 99 parts of plant-derived ethylene glycol (manufactured by Dupont), 114 parts of a 2 mol propylene oxide adduct of bisphenol A (manufactured by Sanyo Chemical Industries, Ltd.), 141 parts of plant-derived succinic acid (manufactured by BASF), 397 parts of terephthalic acid (manufactured by Toray Industries, Inc.), and 64 parts of sodium 5-sulfoisophthalate (manufactured by Tokyo Chemical Industry Co., Ltd.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours. Afterwards, 33 parts of trimellitic anhydride were added to the reaction vessel and the mixture was reacted at 180° C. and normal pressure for 3 hours to obtain [amorphous polyester resin A-1]. The composition and physical property values of the resin are listed in Tables 1 and 2 below.

### Manufacturing Example A-2: Synthesis of Amorphous Polyester Resin A-2

A four-neck flask was equipped with a nitrogen inlet tube, a dehydration tube, a stirrer, and a thermocouple. 266 parts of plant-derived 1,3-butanediol (manufactured by Daicel Corporation), 23 parts of plant-derived ethylene glycol (manufactured by Dupont), 106 parts of a 2 mol propylene oxide adduct of bisphenol A (manufactured by Sanyo Chemical Industries, Ltd.), 87 parts of plant-derived succinic acid (manufactured by BASF), 429 parts of terephthalic acid (manufactured by Toray Industries, Inc.), and 59 parts of sodium 5-sulfoisophthalate (manufactured by Tokyo Chemical Industry Co., Ltd.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours. Afterwards, 31 parts of trimellitic anhydride were added to the reaction vessel and the mixture was reacted at 180° C. and normal pressure for 3 hours to obtain [amorphous polyester resin A-2]. The composition and physical property values of the resin are listed in Tables 1 and 2 below.

### Manufacturing Example A-3: Synthesis of Amorphous Polyester Resin A-3

A four-neck flask was equipped with a nitrogen inlet tube, a dehydration tube, a stirrer, and a thermocouple. 118 parts of plant-derived 1,3-propanediol (manufactured by Dupont), 120 parts of plant-derived ethylene glycol (manufactured by Dupont), 111 parts of a 2 mol propylene oxide adduct of bisphenol A (manufactured by Sanyo Chemical Industries, Ltd.), 113 parts of adipic acid (manufactured by Hayashi Pure Chemical Ind., Ltd.), 386 parts of terephthalic acid (manufactured by Toray Industries, Inc.), and 104 parts of sodium 5-sulfoisophthalate (manufactured by Tokyo Chemical Industry Co., Ltd.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours. Afterwards, 49 parts of trimellitic anhydride were added to the reaction vessel and the mixture was reacted at 180° C. and normal pressure for 3 hours to obtain [amorphous polyester resin A-3]. The composition and physical property values of the resin are listed in Tables 1 and 2 below.

### Manufacturing Example A-4: Synthesis of Amorphous Polyester Resin A-4

A four-neck flask was equipped with a nitrogen inlet tube, a dehydration tube, a stirrer, and a thermocouple. 145 parts of plant-derived 1,3-propanediol (manufactured by Dupont), 181 parts of a 2 mol propylene oxide adduct of bisphenol A (manufactured by Sanyo Chemical Industries, Ltd.), 172 parts of a 2 mol ethylene oxide adduct of bisphenol A (manufactured by Sanyo Chemical Industries, Ltd.), 112 parts of plant-derived succinic acid (manufactured by BASF), 316 parts of terephthalic acid (manufactured by Toray Industries, Inc.), and 34 parts of sodium 5-sulfoisophthalate (manufactured by Tokyo Chemical Industry Co., Ltd.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours. Afterwards, 40 parts of trimellitic anhydride were added to the reaction vessel and the mixture was reacted at 180° C. and normal pressure for 3 hours to obtain [amorphous polyester resin A-3]. The composition and physical property values of the resin are listed in Tables 1 and 2 below.

### Manufacturing Example A-5: Synthesis of Amorphous Polyester Resin A-5

A four-neck flask was equipped with a nitrogen inlet tube, a dehydration tube, a stirrer, and a thermocouple. 211 parts of plant-derived 1,3-propanediol (manufactured by DuPont), 71 parts of plant-derived 1,3-butanediol (manufactured by Daicel Corporation), 113 parts of a 2 mol propylene oxide adduct of bisphenol A (manufactured by Sanyo Chemical Industries, Ltd.), 215 parts of plant-derived succinic acid (manufactured by BASF), 263 parts of terephthalic acid (manufactured by Toray Industries, Inc.), and 42 parts of sodium 5-sulfoisophthalate (manufactured by Tokyo Chemical Industry Co., Ltd.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours. Afterwards, 83 parts of trimellitic anhydride were added to the reaction vessel and the mixture was reacted at 180° C. and normal pressure for 3 hours to obtain [amorphous polyester resin A-5]. The composition and physical property values of the resin are listed in Tables 1 and 2 below.

### Manufacturing Example A-6: Synthesis of Amorphous Polyester Resin A-6

A four-neck flask was equipped with a nitrogen inlet tube, a dehydration tube, a stirrer, and a thermocouple. 237 parts of plant-derived 1,3-butanediol (manufactured by Daicel Corporation), 188 parts of a 2 mol propylene oxide adduct of bisphenol A (manufactured by Sanyo Chemical Industries, Ltd.), 23 parts of plant-derived succinic acid (manufactured by BASF), 436 parts of terephthalic acid (manufactured by Toray Industries, Inc.), and 88 parts of sodium 5-sulfoisophthalate (manufactured by Tokyo Chemical Industry Co., Ltd.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours. Afterwards, 28 parts of trimellitic anhydride were added to the reaction vessel and the mixture was reacted at 180° C. and normal pressure for 3 hours to obtain [amorphous polyester resin A-6]. The composition and physical property values of the resin are listed in Tables 1 and 2 below.

### Manufacturing Example A-7: Synthesis of Amorphous Polyester Resin A-7

A four-neck flask was equipped with a nitrogen inlet tube, a dehydration tube, a stirrer, and a thermocouple. 260 parts of plant-derived ethylene glycol (manufactured by DuPont), 585 parts of isophthalic acid (manufactured by Mitsubishi Gas Chemical Company, Inc.), and 67 parts of sodium 5-sulfoisophthalate (manufactured by Tokyo Chemical Industry Co., Ltd.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours. Afterwards, 88 parts of trimellitic anhydride were added to the reaction vessel and the mixture was reacted at 180° C. and normal pressure for 3 hours to obtain [amorphous polyester resin A-7]. The composition and physical property values of the resin are listed in Tables 1 and 2 below.

### Manufacturing Example A-8: Synthesis of Amorphous Polyester Resin A-8

A four-neck flask was equipped with a nitrogen inlet tube, a dehydration tube, a stirrer, and a thermocouple. 50 parts of plant-derived 1,3-propanediol (manufactured by DuPont), 82 parts of ethylene glycol derived from recycled PET (manufactured by Kyoei J&T Recycling Corporation), 376 parts of a 2 mol propylene oxide adduct of bisphenol A (manufactured by Sanyo Chemical Industries, Ltd.), 186 parts of plant-derived succinic acid (manufactured by BASF), 218 parts of terephthalic acid derived from recycled PET (manufactured by Kyoei J&T Recycling Corporation), and 33 parts of lithium 5-sulfoisophthalate (manufactured by Tokyo Chemical Industry Co., Ltd.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours. Afterwards, 55 parts of trimellitic anhydride were added to the reaction vessel and the mixture was reacted at 180° C. and normal pressure for 3 hours to obtain [amorphous polyester resin A-8]. The composition and physical property values of the resin are listed in Tables 1 and 2 below.

### Manufacturing Example A-9: Synthesis of Amorphous Polyester Resin A-9

A four-neck flask was equipped with a nitrogen inlet tube, a dehydration tube, a stirrer, and a thermocouple. 208 parts of plant-derived 1,3-butanediol (manufactured by Daicel Corporation), 72 parts of ethylene glycol derived from recycled PET (manufactured by Kyoei J&T Recycling Corporation), 110 parts of a 2 mol propylene oxide adduct of bisphenol A (manufactured by Sanyo Chemical Industries, Ltd.), 348 parts of adipic acid (manufactured by Hayashi Pure Chemical Ind., Ltd.), 191 parts of terephthalic acid derived from recycled PET (manufactured by Kyoei J&T Recycling Corporation), and 39 parts of lithium 5-sulfoisophthalate (manufactured by Tokyo Chemical Industry Co., Ltd.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours. Afterwards, 32 parts of trimellitic anhydride were added to the reaction vessel and the mixture was reacted at 180° C. and normal pressure for 3 hours to obtain [amorphous polyester resin A-9].The composition and physical property values of the resin are listed in Tables 1 and 2 below.

### Manufacturing Example A-10: Synthesis of Amorphous Polyester Resin A-10

A four-neck flask was equipped with a nitrogen inlet tube, a dehydration tube, a stirrer, and a thermocouple. 308 parts of a 2 mol propylene oxide adduct of bisphenol A (manufactured by Sanyo Chemical Industries, Ltd.), 293 parts of a 2 mol ethylene oxide adduct of bisphenol A (manufactured by Sanyo Chemical Industries, Ltd.), 66 parts of plant-derived succinic acid (manufactured by BASF), 143 parts of terephthalic acid (manufactured by Toray Industries, Inc.), and 173 parts of lithium 5-sulfoisophthalate (manufactured by Tokyo Chemical Industry Co., Ltd.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours. Afterwards, 18 parts of trimellitic anhydride were added to the reaction vessel and the mixture was reacted at 180° C. and normal pressure for 3 hours to obtain [amorphous polyester resin A-10]. The composition and physical property values of the resin are listed in Tables 1 and 2 below.

### Manufacturing Example A-11: Synthesis of Amorphous Polyester Resin A-11

A four-neck flask was equipped with a nitrogen inlet tube, a dehydration tube, a stirrer, and a thermocouple. 178 parts of plant-derived 1,3-propanediol (manufactured by Dupont), 48 parts of plant-derived ethylene glycol (manufactured by Dupont), 223 parts of a 2 mol propylene oxide adduct of bisphenol A (manufactured by Sanyo Chemical Industries, Ltd.), 258 parts of plant-derived succinic acid (manufactured by BASF), and 259 parts of terephthalic acid (manufactured by Toray Industries, Inc.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours. Afterwards, 33 parts of trimellitic anhydride were added to the reaction vessel and the mixture was reacted at 180° C. and normal pressure for 3 hours to obtain [amorphous polyester resin A-11]. The composition and physical property values of the resin are listed in Tables 1 and 2 below.

### Manufacturing Example A-12: Synthesis of Amorphous Polyester Resin A-12

A four-neck flask was equipped with a nitrogen inlet tube, a dehydration tube, a stirrer, and a thermocouple. 150 parts of plant-derived 1,3-butanediol (manufactured by Daicel Corporation), 41 parts of ethylene glycol derived from recycled PET (manufactured by Kyoei J&T Recycling Corporation), 286 parts of a 2 mol propylene oxide adduct of bisphenol A (manufactured by Sanyo Chemical Industries, Ltd.), 181 parts of plant-derived succinic acid (manufactured by BASF), 166 parts of terephthalic acid derived from recycled PET (manufactured by Kyoei J&T Recycling Corporation), and 36 parts of sodium 5-sulfoisophthalate (manufactured by Tokyo Chemical Industry Co., Ltd.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours. Afterwards, 140 parts of trimellitic anhydride were added to the reaction vessel and the mixture was reacted at 180° C. and normal pressure for 3 hours to obtain [amorphous polyester resin A-12]. The composition and physical property values of the resin are listed in Tables 1 and 2 below.

### Manufacturing Example A-13: Synthesis of Amorphous Polyester Resin A-13

A four-neck flask was equipped with a nitrogen inlet tube, a dehydration tube, a stirrer, and a thermocouple. 327 parts of a 2 mol propylene oxide adduct of bisphenol A (manufactured by Sanyo Chemical Industries, Ltd.), 311 parts of a 2 mol ethylene oxide adduct of bisphenol A (manufactured by Sanyo Chemical Industries, Ltd.), 49 parts of plant-derived succinic acid (manufactured by BASF), and 304 parts of terephthalic acid (manufactured by Toray Industries, Inc.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours. Afterwards, 10 parts of trimellitic anhydride were added to the reaction vessel and the mixture was reacted at 180° C. and normal pressure for 3 hours to obtain [amorphous polyester resin A-13]. The composition and physical property values of the resin are listed in Tables 1 and 2 below.

### Manufacturing Example A-14: Synthesis of Amorphous Polyester Resin A-14

A four-neck flask was equipped with a nitrogen inlet tube, a dehydration tube, a stirrer, and a thermocouple. 252 parts of a 2 mol propylene oxide adduct of bisphenol A (manufactured by Sanyo Chemical Industries, Ltd.), 359 parts of a 2 mol ethylene oxide adduct of bisphenol A (manufactured by Sanyo Chemical Industries, Ltd.), 52 parts of plant-derived succinic acid (manufactured by BASF), 219 parts of isophthalic acid (manufactured by Mitsubishi Gas Chemical Company, Inc.), and 118 parts of sodium 5-sulfoisophthalate (manufactured by Tokyo Chemical Industry Co., Ltd.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours to obtain [amorphous polyester resin A-14]. The composition and physical property values of the resin are listed in Tables 1 and 2 below.

### Manufacturing Example A-15: Synthesis of Amorphous Polyester Resin A-15

A four-neck flask was equipped with a nitrogen inlet tube, a dehydration tube, a stirrer, and a thermocouple. 145 parts of plant-derived 1,3-propanediol (manufactured by Dupont), 178 parts of plant-derived ethylene glycol (manufactured by Dupont), 281 parts of plant-derived succinic acid (manufactured by BASF), and 396 parts of isophthalic acid (manufactured by Mitsubishi Gas Chemical Company, Inc.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours to obtain [amorphous polyester resin A-15]. The composition and physical property values of the resin are listed in Tables 1 and 2 below.

### Manufacturing Example A-16: Synthesis of Amorphous Polyester Resin A-16

A four-neck flask was equipped with a nitrogen inlet tube, a dehydration tube, a stirrer, and a thermocouple. 348 parts of a 2 mol propylene oxide adduct of bisphenol A (manufactured by Sanyo Chemical Industries, Ltd.), 94 parts of ethylene glycol derived from recycled PET (manufactured by Kyoei J&T Recycling Corporation), 83 parts of a 2 mol ethylene oxide adduct of bisphenol A (manufactured by Sanyo Chemical Industries, Ltd.), 222 parts of adipic acid (manufactured by Hayashi Pure Chemical Ind., Ltd.), and 253 parts of terephthalic acid derived from recycled PET (manufactured by Kyoei J&T Recycling Corporation) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours to obtain [amorphous polyester resin A-16]. The composition and physical property values of the resin are listed in Tables 1 and 2 below.

### Manufacturing Example A-17: Synthesis of Amorphous Polyester Resin A-17

A four-neck flask was equipped with a nitrogen inlet tube, a dehydration tube, a stirrer, and a thermocouple. 395 parts of a 2 mol propylene oxide adduct of bisphenol A (manufactured by Sanyo Chemical Industries, Ltd.), 250 parts of a 2 mol ethylene oxide adduct of bisphenol A (manufactured by Sanyo Chemical Industries, Ltd.), 202 parts of adipic acid (manufactured by Hayashi Pure Chemical Ind., Ltd.), and 153 parts of isophthalic acid (manufactured by Mitsubishi Gas Chemical Company, Inc.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours to obtain [amorphous polyester resin A-17]. The composition and physical property values of the resin are listed in Tables 1 and 2 below.

Table 3 indicates the weight average molecular weight and the glass transition temperature Tg of each resin.

TABLE 1

| Amorphous | Monomer type | | | | | | |
|---|---|---|---|---|---|---|---|
| Polyester | Alcohol monomer | | | Acid monomer | | | |
| Resin A No. | 1 | 2 | 3 | 1 | 2 | 3 | 4 |
| A-1 | Plant-derived | Plant-derived | 2 mol propylene oxide | Plant-derived | Terephthalic | Sodium 5- | Trimellitic |
| | 1,3-propanediol | ethylene glycol | adduct of bisphenol A | succinic acid | acid | sulfoisophthalate | acid |
| A-2 | Plant-derived | Plant-derived | 2 mol propylene oxide | Plant-derived | Terephthalic | Sodium 5- | Trimellitic |
| | 1,3-butanediol | ethylene glycol | adduct of bisphenol A | succinic acid | acid | sulfoisophthalate | acid |
| A-3 | Plant-derived | Plant-derived | 2 mol propylene oxide | Adipic acid | Terephthalic | Sodium 5- | Trimellitic |
| | 1,3-propanediol | ethylene glycol | adduct of bisphenol A | | acid | sulfoisophthalate | acid |
| A-4 | Plant-derived | 2 mol propylene oxide | 2 mol ethylene oxide | Plant-derived | Terephthalic | Sodium 5- | Trimellitic |
| | 1,3-propanediol | adduct of bisphenol A | adduct of bisphenol A | succinic acid | acid | sulfoisophthalate | acid |
| A-5 | Plant-derived | Plant-derived | 2 mol propylene oxide | Plant-derived | Terephthalic | Sodium 5- | Trimellitic |
| | 1,3-propanediol | 1,3-butanediol | adduct of bisphenol A | succinic acid | acid | sulfoisophthalate | acid |
| A-6 | Plant-derived | 2 mol propylene oxide | | Plant-derived | Terephthalic | Sodium 5- | Trimellitic |
| | 1,3-butanediol | adduct of bisphenol A | | succinic acid | acid | sulfoisophthalate | acid |
| A-7 | Plant-derived | 2 mol propylene oxide | | Isophthalic | | Sodium 5- | Trimellitic |
| | ethylene glycol | adduct of bisphenol A | | acid | | sulfoisophthalate | acid |
| A-8 | Plant-derived | PET-derived | 2 mol propylene oxide | Plant-derived | PET-derived | Lithium 5- | Trimellitic |
| | 1,3-propanediol | ethylene glycol | adduct of bisphenol A | succinic acid | terephthalic acid | sulfoisophthalate | acid |
| A-9 | Plant-derived | PET-derived | 2 mol propylene oxide | Adipic acid | PET-derived | Lithium 5- | Trimellitic |
| | 1,3-butanediol | ethylene glycol | adduct of bisphenol A | | terephthalic acid | sulfoisophthalate | acid |
| A-10 | 2 mol propylene oxide | 2 mol ethylene oxide | | Plant-derived | Terephthalic | Sodium 5- | Trimellitic |
| | adduct of bisphenol A | adduct of bisphenol A | | succinic acid | acid | sulfoisophthalate | acid |
| A-11 | Plant-derived | Plant-derived | 2 mol propylene oxide | Plant-derived | Terephthalic | | Trimellitic |
| | 1,3-propanediol | ethylene glycol | adduct of bisphenol A | succinic acid | acid | | acid |
| A-12 | Plant-derived | PET-derived | 2 mol propylene oxide | Plant-derived | PET-derived | Sodium 5- | Trimellitic |
| | 1,3-butanediol | ethylene glycol | adduct of bisphenol A | succinic acid | terephthalic acid | sulfoisophthalate | acid |
| A-13 | 2 mol propylene oxide | 2 mol ethylene oxide | | Plant-derived | Terephthalic | | Trimellitic |
| | adduct of bisphenol A | adduct of bisphenol A | | succinic acid | acid | | acid |
| A-14 | 2 mol propylene oxide | 2 mol ethylene oxide | | Plant-derived | Isophthalic | Sodium 5- | |
| | adduct of bisphenol A | adduct of bisphenol A | | succinic acid | acid | sulfoisophthalate | |
| A-15 | Plant-derived | Plant-derived | 2 mol propylene oxide | Plant-derived | Isophthalic | | |
| | 1,3-propanediol | ethylene glycol | adduct of bisphenol A | succinic acid | acid | | |
| A-16 | 2 mol propylene oxide | PET-derived | 2 mol ethylene oxide | Adipic acid | PET-derived | | |
| | adduct of bisphenol A | ethylene glycol | adduct of bisphenol A | | terephthalic acid | | |
| A-17 | 2 mol propylene oxide | 2 mol ethylene oxide | | Adipic acid | Isophthalic | | |
| | adduct of bisphenol A | adduct of bisphenol A | | | acid | | |

TABLE 2

| Amorphous | Mass ratio | | | | | | | Number of moles | | | |
|---|---|---|---|---|---|---|---|---|---|---|---|
| Polyester | Alcohol monomer | | | Acid monomer | | | | Alcohol monomer | | | Acid monomer |
| Resin A No. | 1 | 2 | 3 | 1 | 2 | 3 | 4 | 1 | 2 | 3 | 1 |
| A-1 | 152 | 99 | 114 | 141 | 397 | 64 | 33 | 25 | 20 | 5 | 15 |
| A-2 | 266 | 23 | 106 | 87 | 429 | 59 | 31 | 40 | 5 | 5 | 10 |
| A-3 | 118 | 120 | 111 | 113 | 386 | 104 | 49 | 20 | 25 | 5 | 10 |
| A-4 | 145 | 181 | 172 | 112 | 316 | 34 | 40 | 30 | 10 | 10 | 15 |
| A-5 | 211 | 71 | 113 | 215 | 263 | 42 | 83 | 35 | 10 | 5 | 23 |
| A-6 | 237 | 188 | 0 | 23 | 436 | 88 | 28 | 40 | 10 | 0 | 3 |
| A-7 | 260 | 0 | 0 | 585 | 0 | 67 | 88 | 50 | 0 | 0 | 42 |
| A-8 | 50 | 82 | 376 | 186 | 218 | 33 | 55 | 10 | 20 | 20 | 24 |
| A-9 | 208 | 72 | 110 | 348 | 191 | 39 | 32 | 30 | 15 | 5 | 31 |
| A-10 | 308 | 293 | 0 | 66 | 143 | 173 | 18 | 25 | 25 | 0 | 13 |
| A-11 | 178 | 48 | 223 | 258 | 259 | 0 | 33 | 30 | 10 | 10 | 28 |
| A-12 | 150 | 41 | 286 | 181 | 166 | 36 | 140 | 25 | 10 | 15 | 23 |
| A-13 | 327 | 311 | 0 | 49 | 304 | 0 | 10 | 25 | 25 | 0 | 9 |
| A-14 | 252 | 359 | 0 | 52 | 219 | 118 | 0 | 20 | 30 | 0 | 10 |
| A-15 | 145 | 178 | 0 | 281 | 396 | 0 | 0 | 20 | 30 | 0 | 25 |
| A-16 | 348 | 94 | 83 | 222 | 253 | 0 | 0 | 20 | 25 | 5 | 25 |
| A-17 | 395 | 250 | 0 | 202 | 153 | 0 | 0 | 30 | 20 | 0 | 30 |

| Amorphous | Number of moles | | | Ratio of plant- | | | | |
|---|---|---|---|---|---|---|---|---|
| Polyester | Acid monomer | | | derived | | | | Content of |
| Resin A No. | 2 | 3 | 4 | components | AVa | OHVa | OHVa/AVa | surfactant |
| A-1 | 30 | 3 | 2 | 39 | 22 | 23 | 1.1 | 1 |
| A-2 | 35 | 3 | 2 | 38 | 20 | 25 | 1.2 | 0 |
| A-3 | 30 | 5 | 3 | 24 | 23 | 34 | 1.5 | 0 |
| A-4 | 30 | 2 | 3 | 26 | 23 | 33 | 1.5 | 0 |
| A-5 | 20 | 2 | 5 | 50 | 19 | 25 | 1.3 | 2.1 |
| A-6 | 40 | 5 | 2 | 26 | 20 | 25 | 1.2 | 0.5 |
| A-7 | 0 | 3 | 5 | 26 | 27 | 28 | 1.1 | 1 |
| A-8 | 20 | 2 | 4 | 24 | 23 | 30 | 1.3 | 3.5 |
| A-9 | 15 | 2 | 2 | 21 | 20 | 22 | 1.1 | 4 |
| A-10 | 20 | 15 | 2 | 7 | 18 | 23 | 1.3 | 1.2 |
| A-11 | 20 | 0 | 2 | 48 | 17 | 22 | 1.3 | 1.5 |
| A-12 | 15 | 2 | 10 | 33 | 37 | 22 | 0.6 | 0.5 |
| A-13 | 40 | 0 | 1 | 5 | 18 | 22 | 1.2 | 0.9 |
| A-14 | 30 | 10 | 0 | 5 | 4 | 22 | 5.9 | 1.4 |
| A-15 | 25 | 0 | 0 | 60 | 4 | 24 | 5.6 | 1.3 |
| A-16 | 25 | 0 | 0 | 0 | 2 | 25 | 10.7 | 0.4 |
| A-17 | 20 | 0 | 0 | 0 | 6 | 22 | 3.6 | 3.6 |

TABLE 3

| Amorphous Polyester | Weight average | Tg |
|---|---|---|
| Resin A No. | molecular weight | [° C.] |
| A-1 | 15,000 | 68 |
| A-2 | 14,000 | 70 |
| A-3 | 14,000 | 71 |
| A-4 | 16,000 | 72 |
| A-5 | 17,000 | 69 |
| A-6 | 13,000 | 65 |
| A-7 | 15,000 | 74 |
| A-8 | 16,000 | 71 |
| A-9 | 17,000 | 70 |
| A-10 | 18,000 | 69 |
| A-11 | 15,000 | 67 |
| A-12 | 11,000 | 65 |
| A-13 | 13,000 | 68 |
| A-14 | 14,000 | 66 |
| A-15 | 15,000 | 74 |
| A-16 | 16,000 | 73 |
| A-17 | 15,000 | 64 |

### Manufacturing Example B-1: Synthesis of Amorphous Polyester Resin B-1

A four-neck flask was equipped with a nitrogen inlet tube, a dehydration tube, a stirrer, and a thermocouple. 178 parts of plant-derived 1,3-propanediol (manufactured by Dupont), 48 parts of plant-derived ethylene glycol (manufactured by Dupont), 223 parts of a 2 mol propylene oxide adduct of bisphenol A (manufactured by Sanyo Chemical Industries, Ltd.), 258 parts of plant-derived succinic acid (manufactured by BASF), and 259 parts of terephthalic acid (manufactured by Toray Industries, Inc.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours. Afterwards, 33 parts of trimellitic anhydride were added to the reaction vessel and the mixture was reacted at 180° C. and normal pressure for 3 hours to obtain [amorphous polyester resin B-1]. The composition and physical property values of the resin are listed in Table 4 below.

### Manufacturing Example B-2: Synthesis of Amorphous Polyester Resin B-2

A four-neck flask was equipped with a nitrogen inlet tube, a dehydration tube, a stirrer, and a thermocouple. 322 parts of a 2 mol propylene oxide adduct of bisphenol A (manufactured by Sanyo Chemical Industries, Ltd.), 306 parts of a 2 mol ethylene oxide adduct of bisphenol A (manufactured by Sanyo Chemical Industries, Ltd.), 27 parts of plant-derived succinic acid (manufactured by BASF), and 299 parts of terephthalic acid (manufactured by Toray Industries, Inc.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours. Afterwards, 47 parts of trimellitic anhydride were added to the reaction vessel and the mixture was reacted at 180° C. and normal pressure for 3 hours to obtain [amorphous polyester resin B-2]. The composition and physical property values of the resin are listed in Table 4 below.

### Manufacturing Example B-3: Synthesis of Amorphous Polyester Resin B-3

A four-neck flask was equipped with a nitrogen inlet tube, a dehydration tube, a stirrer, and a thermocouple. 395 parts of a 2 mol propylene oxide adduct of bisphenol A (manufactured by Sanyo Chemical Industries, Ltd.), 250 parts of a 2 mol ethylene oxide adduct of bisphenol A (manufactured by Sanyo Chemical Industries, Ltd.), 202 parts of adipic acid (manufactured by Hayashi Pure Chemical Ind., Ltd.), and 153 parts of isophthalic acid (manufactured by Mitsubishi Gas Chemical Company, Inc.) were filled into the flask and reacted with titanium tetraisopropoxide (500 ppm with respect to the resin component) at normal pressure and 230° C. for 8 hours. The mixture was further reacted at a reduced pressure of 10 mmHg to 15 mmHg for 4 hours to obtain [amorphous polyester resin B-3]. The composition and physical property values of the resin are listed in Table 4 below.

Table 5 indicates the weight average molecular weight and the glass transition temperature Tg of each resin.

TABLE 4

| Amorphous | Alcohol Monomer 1 | | | | | | Alcohol Monomer 1 | | |
|---|---|---|---|---|---|---|---|---|---|
| Polyester | Alcohol monomer | | | Acid monomer | | | Alcohol monomer | | |
| Resin B No. | 1 | 2 | 3 | 1 | 2 | 3 | 1 | 2 | 3 |
| B-1 | Plant- | Plant- | 2 mol | Plant- | Terephthalic | Trimellitic | 178 | 48 | 223 |
| | derived | derived | propylene | derived | acid | acid | | | |
| | 1,3-propanediol | ethylene | oxide adduct of | succinic acid | | | | | |
| | | glycol | bisphenol A | | | | | | |
| B-2 | 2 mol | 2 mol | | Plant- | Terephthalic | Trimellitic | 322 | 306 | 0 |
| | propylene | ethylene | | derived | acid | acid | | | |
| | oxide adduct of | oxide adduct of | | succinic | | | | | |
| | bisphenol A | bisphenol A | | acid | | | | | |
| B-3 | 2 mol | 2 mol | | Adipic acid | Isophthalic | | 395 | 250 | 0 |
| | propylene | ethylene | | | acid | | | | |
| | bisphenol A | bisphenol A | | | | | | | |

| Amorphous | Alcohol Monomer 1 | | | Alcohol Monomer 1 | | | | | | | | |
|---|---|---|---|---|---|---|---|---|---|---|---|---|
| Polyester | Acid monomer | | | Alcohol monomer | | | Acid monomer | | | | | |
| Resin B No. | 1 | 2 | 3 | 1 | 2 | 3 | 1 | 2 | 3 | AVa | OHVa | OHVa/Ava |
| B-1 | 258 | 259 | 33 | 30 | 10 | 10 | 28 | 20 | 2 | 17 | 22 | 1.3 |
| B-2 | 27 | 299 | 47 | 25 | 25 | 0 | 5 | 40 | 5 | 23 | 22 | 1 |
| B-3 | 202 | 153 | 0 | 30 | 20 | 0 | 30 | 20 | 0 | 6 | 22 | 3.6 |

TABLE 5

| Amorphous Polyester | Weight average | Tg |
|---|---|---|
| Resin B No. | molecular weight | [° C.] |
| B-1 | 9,000 | 54 |
| B-2 | 8,500 | 53 |
| B-3 | 10,000 | 55 |

### Example 1

### Preparation of Aqueous Dispersion of Amorphous Polyester Resin A

### Preparation of Oil Phase

150 parts of [amorphous polyester resin A-1] and 150 parts of methyl ethyl ketone were filled into in a container and mixed at 7,000 rpm for 60 minutes by using a TK HOMO MIXER (manufactured by Primix Corporation) to obtain [Oil Phase 1].

Note that the blending amount of each component refers to the blending amount of solid content in each raw material, and the same applies to the following steps.

### Preparation of Aqueous Phase

800 parts of ion-exchanged water was used as [Aqueous Phase 1].

### Phase Inversion Emulsification

700 parts of [Oil Phase 1] was stirred with a TK HOMO MIXER at a rotation speed of 5,000 rpm, while 10 parts of 10% sodium hydroxide was added, and the mixture was mixed for 10 minutes. 1.0 wt % of sodium dodecyl sulfate with respect to the solid content of [Oil Phase 1] was added and the mixture was mixed for 10 minutes. Subsequently, 1,200 parts of [Aqueous Phase 1] was gradually added dropwise to obtain [Emulsified Slurry 1].

### Solvent Removal

[Emulsified Slurry 1] was filled into in a container equipped with a stirrer and a thermometer, and the solvent was removed at 30° C. for 180 minutes, to obtain [Polyester Water Dispersion 1]. The resin particles contained in [Polyester Water Dispersion 1] had a volume average particle diameter of 50 nm and a solid content concentration of 25%.

### Preparation of Masterbatch

1,200 parts of water, 500 parts of carbon black (PRINTEX 35, manufactured by Degussa AG) [DBP oil absorption amount=42 mL/100 mg, pH=9.5], and 500 parts of [amorphous polyester resin B-1] were added to and mixed in a Henschel mixer (manufactured by Nippon Coke & Engineering Co., Ltd.). The mixture was kneaded by using two rolls at 150° C. for 30 minutes, and then, rolled to cool, and pulverized in a pulverizer to obtain [Masterbatch 1].

### Preparation of Resin Particles

### Preparation of Oil Phase

750 parts of [amorphous polyester resin B-1] and 50 parts of [Master Batch 1] (pigment) were filled into a container and mixed at 7,000 rpm for 60 minutes by using a TK HOMO MIXER (manufactured by Primix Corporation) to obtain [Oil Phase 2].

Note that the blending amount of each component refers to the blending amount of solid content in each raw material, and the same applies to the following steps.

### Preparation of Aqueous Phase

990 parts of water, 25 parts of sodium dodecyl sulfate, and 90 parts of ethyl acetate were mixed and stirred to obtain a milky white liquid. The obtained liquid was used as [Aqueous Phase 2].

### Phase Inversion Emulsification

While stirring 700 parts of [Oil Phase 2] at a rotation speed of 5,000 rpm by using a TK HOMO MIXER, 20 parts of 28% aqueous ammonia was added, and the mixture was mixed for 10 minutes. Afterwards, 1,200 parts of [Aqueous Phase 2] was gradually added dropwise to obtain [Emulsified Slurry 2].

### Solvent Removal

[Emulsified Slurry 2] was filled into a container equipped with a stirrer and a thermometer, and the solvent was removed at 30° C. for 180 minutes, to obtain [Desolvated Slurry 2]. The volume average particle diameter of the particles contained in [Desolvated Slurry 2] was 0.35 μm.

### Aggregation

100 parts of a 10% magnesium sulfate solution was added dropwise to [Desolvated Slurry 2], and the mixture was stirred for another 5 minutes. Subsequently, the temperature was raised to 60° C., and when the particle diameter reached 5.0 μm, 200 parts of [Polyester Water Dispersion 1] was added dropwise, and the mixture was stirred for 60 minutes. Afterwards, 200 parts of a 10% aqueous sodium chloride solution was added to finish the aggregation step, and [Aggregated Slurry 1] was obtained.

### Fusion

[Aggregated Slurry 1] was heated to 70° C. while stirring, and cooled when the desired average circularity of 0.961 was reached, to obtain [Dispersed Slurry 1].

### Washing and Drying

100 parts of [Dispersed Slurry 1] was filtered under reduced pressure, and then, the following operations (1) to (4) were performed twice to obtain [Filter Cake 1].

(1): 100 parts of ion-exchanged water was added to the filter cake, the mixture was mixed by using a TK HOMO MIXER (at a rotation speed of 12,000 rpm for 10 minutes) and then, the mixture was filtered.

(2): 100 parts of a 10% aqueous sodium hydroxide solution was added to the filter cake obtained in (1) above, and the mixture was mixed by using a TK HOMO MIXER (at a rotation speed of 12,000 rpm for 30 minutes), and then, the mixture was filtered under reduced pressure.

(3): 100 parts of 10% hydrochloric acid was added to the filter cake obtained in (2) above, the mixture was mixed by using a TK HOMO MIXER (at a rotation speed of 12,000 rpm for 10 minutes) and then, the mixture was filtered.

(4): 300 parts of ion-exchanged water was added to the filter cake obtained in (3) above, the mixture was mixed by using a TK HOMO MIXER (at a rotation speed of 12,000 rpm for 10 minutes) and then, the mixture was filtered.

The obtained [Filter Cake 1] was dried in a circulating air dryer at 45° C. for 48 hours, and sieved through a sieve having 75 μm mesh openings to obtain [Resin Particles 1]. The [Resin Particles 1] were used as [Toner Base Particles 1] in producing the toner.

### External Additive Treatment Step

2.0 parts of hydrophobic silica (HDK (registered trademark) H2000, manufactured by Clariant AG) as an external additive with respect to 100 parts of [Toner Base Particles 1] were mixed in a Henschel mixer, and the mixture was passed through a sieve having 500 mesh openings to obtain [Toner 1].

### Example 2

[Polyester Water Dispersion 2], [Resin Particles 2], and [Toner 2] were obtained similarly to Example 1, except that [amorphous polyester resin A-1] was changed to [amorphous polyester resin A-2] and the amount of sodium dodecyl sulfate in the <Transfer Emulsification> was changed from 1.0 wt % to 0.0 wt %. The resin particles in the obtained [Polyester Water Dispersion 2] had a volume average particle diameter of 62 nm and a solid content concentration of 25%.

### Example 3

[Polyester Water Dispersion 3], [Resin Particles 3], and [Toner 3] were obtained similarly to Example 1, except that [amorphous polyester resin A-1] was changed to [amorphous polyester resin A-3] and the amount of sodium dodecyl sulfate in the <Transfer Emulsification> was changed from 1.0 wt % to 0.0 wt %. The resin particles in the obtained [Polyester Water Dispersion 3] had a volume average particle diameter of 72 nm and a solid content concentration of 25%.

### Example 4

[Polyester Water Dispersion 4], [Resin Particles 4], and [Toner 4] were obtained similarly to Example 1, except that [amorphous polyester resin A-1] was changed to [amorphous polyester resin A-4], the amount of sodium dodecyl sulfate in <Transfer Emulsification> was changed from 1.0 wt % to 0.0 wt %, and [amorphous polyester resin B-1] in <<Preparation of Oil Phase>> in the section <Preparation of Resin Particles> was changed to [amorphous polyester resin B-2]. The resin particles in the obtained [Polyester Water Dispersion 4] had a volume average particle diameter of 54 nm and a solid content concentration of 25%.

### Example 5

[Polyester Water Dispersion 5], [Resin Particles 5], and [Toner 5] were obtained similarly to Example 1, except that [amorphous polyester resin A-1] was changed to [amorphous polyester resin A-5], the amount of sodium dodecyl sulfate in <Transfer Emulsification> was changed from 1.0 wt % to 2.1 wt %, and [amorphous polyester resin B-1] in <<Preparation of Oil Phase>> in the section <Preparation of Resin Particles> was changed to [amorphous polyester resin B-2]. The resin particles in the obtained [Polyester Water Dispersion 5] had a volume average particle diameter of 23 nm and a solid content concentration of 25%.

### Example 6

[Polyester Water Dispersion 6], [Resin Particles 6], and [Toner 6] were obtained similarly to Example 1, except that [amorphous polyester resin A-1] was changed to [amorphous polyester resin A-6], 1.0 wt % of sodium dodecyl sulfate in <Transfer Emulsification> was changed to 0.5 wt % of ammonium dodecyl sulfate, and [amorphous polyester resin B-1] in <<Preparation of Oil Phase>> in the section <Preparation of Resin Particles> was changed to [amorphous polyester resin B-3]. The resin particles in the obtained [Polyester Water Dispersion 6] had a volume average particle diameter of 40 nm and a solid content concentration of 25%.

### Example 7

[Polyester Water Dispersion 7], [Resin Particles 7], and [Toner 7] were obtained similarly to Example 1, except that [amorphous polyester resin A-1] was changed to [amorphous polyester resin A-7], the amount of sodium dodecyl sulfate in <Transfer Emulsification> was changed from 1.0 wt % to 0.9 wt %, and [amorphous polyester resin B-1] in <<Preparation of Oil Phase>> in the section <Preparation of Resin Particles> was changed to [amorphous polyester resin B-3]. The resin particles in the obtained [Polyester Water Dispersion 7] had a volume average particle diameter of 32 nm and a solid content concentration of 25%.

### Example 8

[Polyester Water Dispersion 8], [Resin Particles 8], and [Toner 8] were obtained similarly to Example 1, except that [amorphous polyester resin A-1] was changed to [amorphous polyester resin A-8] and the amount of sodium dodecyl sulfate in <Transfer Emulsification> was changed from 1.0 wt % to 3.5 wt %.

The resin particles in the obtained [Polyester Water Dispersion 8] had a volume average particle diameter of 12 nm and a solid content concentration of 25%.

### Example 9

[Polyester Water Dispersion 9], [Resin Particles 9], and [Toner 9] were obtained similarly to Example 1, except that [amorphous polyester resin A-1] was changed to [amorphous polyester resin A-9] and the amount of sodium dodecyl sulfate in <Transfer Emulsification> was changed from 1.0 wt % to 4.0 wt %.

The resin particles in the obtained [Polyester Water Dispersion 9] had a volume average particle diameter of 10 nm and a solid content concentration of 25%.

### Comparative Example 1

[Polyester Water Dispersion 10], [Resin Particles 10], and [Toner 10] were obtained similarly to Example 1, except that [amorphous polyester resin A-1] was changed to [amorphous polyester resin A-10] and the amount of sodium dodecyl sulfate in <Transfer Emulsification> was changed from 1.0 wt % to 1.2 wt %. The resin particles in the obtained [Polyester Water Dispersion 10] had a volume average particle diameter of 48 nm and a solid content concentration of 25%.

### Comparative Example 2

[Polyester Water Dispersion 11], [Resin Particles 11], and [Toner 11] were obtained similarly to Example 1, except that [amorphous polyester resin A-1] was changed to [amorphous polyester resin A-11] and the amount of sodium dodecyl sulfate in <Transfer Emulsification> was changed from 1.0 wt % to 1.5 wt %. The resin particles in the obtained [Polyester Water Dispersion 11] had a volume average particle diameter of 41 nm and a solid content concentration of 25%.

### Comparative Example 3

[Polyester Water Dispersion 12], [Resin Particles 12], and [Toner 12] were obtained similarly to Example 1, except that [amorphous polyester resin A-1] was changed to [amorphous polyester resin A-12] and the amount of sodium dodecyl sulfate in <Transfer Emulsification> was changed from 1.0 wt % to 0.5 wt %. The resin particles in the obtained [Polyester Water Dispersion 12] had a volume average particle diameter of 49 nm and a solid content concentration of 25%.

### Comparative Example 4

[Polyester Water Dispersion 13], [Resin Particles 13], and [Toner 13] were obtained similarly to Example 1, except that [amorphous polyester resin A-1] was changed to [amorphous polyester resin A-13] and the amount of sodium dodecyl sulfate in <Transfer Emulsification> was changed from 1.0 wt % to 0.9 wt %. The resin particles in the obtained [Polyester Water Dispersion 13] had a volume average particle diameter of 51 nm and a solid content concentration of 25%.

### Comparative Example 5

[Polyester Water Dispersion 14], [Resin Particles 14], and [Toner 14] were obtained similarly to Example 1, except that [amorphous polyester resin A-1] was changed to [amorphous polyester resin A-14], the amount of sodium dodecyl sulfate in <Transfer Emulsification> was changed from 1.0 wt % to 1.4 wt %, and [amorphous polyester resin B-1] in <<Preparation of Oil Phase>> in the section <Preparation of Resin Particles> was changed to [amorphous polyester resin B-2]. The resin particles in the obtained [Polyester Water Dispersion 14] had a volume average particle diameter of 33 nm and a solid content concentration of 25%.

### Comparative Example 6

[Polyester Water Dispersion 15], [Resin Particles 15], and [Toner 15] were obtained similarly to Example 1, except that [amorphous polyester resin A-1] was changed to [amorphous polyester resin A-15], the amount of sodium dodecyl sulfate in <Transfer Emulsification> was changed from 1.0 wt % to 1.3 wt %, and [amorphous polyester resin B-1] in <<Preparation of Oil Phase>> in the section <Preparation of Resin Particles> was changed to [amorphous polyester resin B-2]. The resin particles in the obtained [Polyester Water Dispersion 15] had a volume average particle diameter of 30 nm and a solid content concentration of 25%.

### Comparative Example 7

[Polyester Water Dispersion 16], [Resin Particles 16], and [Toner 16] were obtained similarly to Example 1, except that [amorphous polyester resin A-1] was changed to [amorphous polyester resin A-16], the amount of sodium dodecyl sulfate in <Transfer Emulsification> was changed from 1.0 wt % to 0.4 wt %, and [amorphous polyester resin B-1] in <<Preparation of Oil Phase>> in the section <Preparation of Resin Particles> was changed to [amorphous polyester resin B-2]. The resin particles in the obtained [Polyester Water Dispersion 16] had a volume average particle diameter of 56 nm and a solid content concentration of 25%.

### Comparative Example 8

[Polyester Water Dispersion 17], [Resin Particles 17], and [Toner 17] were obtained similarly to Example 1, except that [amorphous polyester resin A-1] was changed to [amorphous polyester resin A-17], the amount of sodium dodecyl sulfate in <Transfer Emulsification> was changed from 1.0 wt % to 3.6 wt %, and [amorphous polyester resin B-1] in <<Preparation of Oil Phase>> in the section <Preparation of Resin Particles> was changed to [amorphous polyester resin B-3]. The resin particles in the obtained [Polyester Water Dispersion 17] had a volume average particle diameter of 10 nm and a solid content concentration of 25%.

### Preparation of Carrier

200 parts of a silicone resin solution (manufactured by Shin-Etsu Chemical Co., Ltd.) and 3 parts of carbon black (manufactured by Cabot Corporation) were dispersed in toluene to obtain a coating liquid.

A fluidized bed spray device AGGLOMASTER AGM-PJ (manufactured by Hosokawa Micron Corporation) was used to apply the coating liquid to 2500 parts of a ferrite core material (manufactured by Toda Kogyo Corp.), and then, the material was fired in an electric furnace at 300° C. for 2 hours to obtain [Carrier 1]. The average particle diameter in [Carrier 1] was 36 μm.

### Preparation of Developer

A TURBULA MIXER T10B (manufactured by Shinmaru Enterprises Corporation) was used to mix 7 parts of [Toner 1] to [Toner 17] with 93 parts of [Carrier 1] to obtain [Developer 1] to [Developer 17].

For each of the polyester water dispersions and the resin particles obtained in Examples 1 to 9 and Comparative Examples 1 to 8, the environmental compatibility of the polyester resin in each polyester water dispersion and the charge amount distribution of the resin particles were evaluated by the following methods. The results are indicated in Table 6 below.

### Evaluation Method

### Environmental Compatibility of Polyester Resin

The “environmental compatibility” was evaluated according to the following evaluation criteria, based on the environmentally friendly component ratio of the portion of the amorphous polyester soluble in chloroform in each of the polyester water dispersions.

### Method of Measuring Environmentally Friendly Component Ratio of Amorphous Polyester in Polyester Water Dispersion

1 g of polyester resin particles separated from [Polyester Water Dispersion 1] to [Polyester Water Dispersion 17] was added to 100 mL of chloroform, and the mixture was stirred at 25° C. for 30 minutes to obtain a solution in which the soluble portion was dissolved.

The obtained solution was filtered through a membrane filter having openings of 0.2 μm to obtain a portion of the toner soluble in chloroform. Subsequently, the portion was dried at 45° C. for 24 hours and combusted to reduce carbon dioxide (CO₂) and obtain graphite (C). The concentration of the radioactive carbon isotope ¹⁴C in the graphite (C) was measured by using an accelerator mass spectrometer (AMS, manufactured by BetaAnalytic). The measured ¹⁴C concentration was substituted into Equation (1) below to calculate the “plant-derived component ratio” in the resin particles.

An oxalic acid standard (HOxII, manufactured by NIST) was used as a standard material.

$$Evaluation Criteria for “ Environmental Compatibility ”$$

$$Plant - derived component ratio ( \% ) = {}^{14} C concentration ( pMC ) / 107.5 * 100 \qquad Equation ( 1 )$$

A: 40% or more
B: 20% or more and less than 40%
F: Less than 20%

### Uniformity of Charging Properties (Background contamination)

The developer obtained as described above was filled into a Bk cartridge of IMAGIO MP C5503 manufactured by Ricoh, and a 5% chart of Test Chart No. 8 published by The Imaging Society of Japan was printed out on one white sheet of paper. The surface of the white sheet of paper and the photoconductor were visually observed.

### Evaluation Criteria for Uniformity of Charging Properties

A: No adhesion of resin particles is observed on the white sheet of paper and the photoconductor.

B: No adhesion of resin particles is observed on the white sheet of paper, but some resin particles attached to the photoconductor are observed when the photoconductor is tilted and observed.

F: Adhesion of resin particles is clearly observed on the white sheet of paper.

TABLE 6

| | | | | | | Evaluation results of resin | |
|---|---|---|---|---|---|---|---|
| Example, | | Amorphous | Amorphous | | | particles | |
| Comparative | Resin | Polyester | Polyester | Resin Particles | | | Uniformity |
| Example | Particles | Resin A | Resin B | | Particle | Environmental | of charging |
| No. | No. | (shell) | (core) | Circularity | diameter | compatibility | properties |
| Example 1 | Resin | A-1 | B-1 | 0.965 | 5.0 | B | A |
| | Particles 1 | | | | | | |
| Example 2 | Resin | A-2 | B-1 | 0.964 | 5.7 | B | A |
| | Particles 2 | | | | | | |
| Example 3 | Resin | A-3 | B-1 | 0.967 | 5.2 | B | A |
| | Particles 3 | | | | | | |
| Example 4 | Resin | A-4 | B-2 | 0.968 | 5.0 | B | A |
| | Particles 4 | | | | | | |
| Example 5 | Resin | A-5 | B-2 | 0.963 | 5.1 | A | A |
| | Particles 5 | | | | | | |
| Example 6 | Resin | A-6 | B-3 | 0.962 | 4.7 | B | B |
| | Particles 6 | | | | | | |
| Example 7 | Resin | A-7 | B-3 | 0.960 | 4.9 | B | B |
| | Particles 7 | | | | | | |
| Example 8 | Resin | A-8 | B-1 | 0.968 | 4.5 | B | B |
| | Particles 8 | | | | | | |
| Example 9 | Resin | A-9 | B-1 | 0.970 | 5.3 | B | B |
| | Particles 9 | | | | | | |
| Comparative | Resin | A-10 | B-1 | 0.956 | 5.4 | F | A |
| Example 1 | Particles 10 | | | | | | |
| Comparative | Resin | A-11 | B-1 | 0.971 | 4.9 | A | F |
| Example 2 | Particles 11 | | | | | | |
| Comparative | Resin | A-12 | B-1 | 0.972 | 5.1 | B | F |
| Example 3 | Particles 12 | | | | | | |
| Comparative | Resin | A-13 | B-1 | 0.960 | 5.2 | F | F |
| Example 4 | Particles 13 | | | | | | |
| Comparative | Resin | A-14 | B-2 | 0.956 | 5.3 | F | F |
| Example 5 | Particles 14 | | | | | | |
| Comparative | Resin | A-15 | B-2 | 0.974 | 4.7 | A | F |
| Example 6 | Particles 15 | | | | | | |
| Comparative | Resin | A-16 | B-2 | 0.976 | 4.6 | F | F |
| Example 7 | Particles 16 | | | | | | |
| Comparative | Resin | A-17 | B-3 | 0.951 | 4.8 | F | F |
| Example 8 | Particles 17 | | | | | | |

Aspects of the present disclosure include the following, for example.

According to a first aspect, in an amorphous polyester resin is a polycondensation product of an alcohol component and a carboxylic acid component, where the alcohol component includes at least one selected from the group consisting of plant-derived 1,3-propanediol, plant-derived 1,3-butanediol, and plant-derived ethylene glycol, the carboxylic acid component includes a polycarboxylic acid having a sulfo group, and
a ratio (OHVa/AVa) of a hydroxyl value (OHVa) of the amorphous polyester resin with respect to an acid value (AVa) of the amorphous polyester resin is from 1.1 to 1.5.

In a second aspect, a polyester water dispersion includes water and resin particles containing the amorphous polyester resin according to the above-described first aspect, dispersed in water.

In a third aspect, the polyester water dispersion according to the above-described second aspect includes a surfactant in an amount of 0 mass % or more and 3.0 mass % or less with respect to 100 mass % of the resin particles in the polyester water dispersion.

According to a fourth aspect, a method of manufacturing the polyester water dispersion according to the third aspect includes:
dissolving or dispersing the amorphous polyester resin in an organic solvent to prepare an oil phase; and
adding water to the oil phase to cause phase inversion from a water-in-oil dispersion liquid to an oil-in-water dispersion liquid.

According to a fifth aspect, in resin particles each having a core-shell structure, each of the resin particles includes: a shell layer including amorphous polyester resin A comprising the amorphous polyester resin according to the above-described first aspect; and a core layer including an amorphous polyester resin B.

According to a sixth aspect, a method of manufacturing the resin particles according to the above-described fifth aspect includes:
dissolving or dispersing the amorphous polyester resin B in an organic solvent to prepare an oil phase;
adding water to the oil phase to cause phase inversion from a water-in-oil dispersion liquid to an oil-in-water dispersion liquid;
aggregating dispersed particles in the oil-in-water dispersion liquid; and
after the aggregating, adding a polyester water dispersion containing the amorphous polyester resin A to the oil-in-water dispersion liquid to aggregate the amorphous polyester resin A in the polyester water dispersion.

According to a seventh aspect, toner resin particles include the resin particles according to the above-described fifth aspect.

According to an eighth aspect, a toner includes the toner resin particles according to the above-described seventh aspect.

According to a ninth aspect, a developer includes the toner according to the above-described eighth aspect.

According to a tenth aspect, a toner storage unit stores the toner according to the above-described eighth aspect.

According to an eleventh aspect, an image forming apparatus includes:
an electrostatic latent image bearer;
an electrostatic latent image forming device to form an electrostatic latent image on the electrostatic latent image bearer; and
a developing device including the toner according to the above-described eighth aspect to develop the electrostatic latent image formed on the electrostatic latent image bearer with the toner to form a visible image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An amorphous polyester resin comprising:
a polycondensation product of an alcohol component and a carboxylic acid component,
the alcohol component including at least one selected from the group consisting of plant-derived 1,3-propanediol, plant-derived 1,3-butanediol, and plant-derived ethylene glycol, and
the carboxylic acid component including a polycarboxylic acid having a sulfo group, and
wherein a ratio (OHVa/AVa) of a hydroxyl value (OHVa) of the amorphous polyester resin with respect to an acid value (AVa) of the amorphous polyester resin is from 1.1 to 1.5.

2. A polyester water dispersion comprising:
water; and
resin particles containing the amorphous polyester resin according to claim 1, dispersed in the water.

3. The polyester water dispersion according to claim 2, further comprising:
a surfactant in an amount of 0 mass % or more and 3.0 mass % or less with respect to 100 mass % of the resin particles in the polyester water dispersion.

4. A method of manufacturing the polyester water dispersion according to claim 3, the method comprising:
dissolving or dispersing the amorphous polyester resin in an organic solvent to prepare an oil phase; and
adding water to the oil phase to cause phase inversion from a water-in-oil dispersion liquid to an oil-in-water dispersion liquid.

5. Resin particles each having a core-shell structure, each of the resin particles comprising:
a shell layer comprising an amorphous polyester resin A comprising the amorphous polyester resin according to claim 1; and
a core layer comprising an amorphous polyester resin B.

6. A method of manufacturing the resin particles according to claim 5, the method comprising:
dissolving or dispersing the amorphous polyester resin B in an organic solvent to prepare an oil phase;
adding water to the oil phase to cause phase inversion from a water-in-oil dispersion liquid to an oil-in-water dispersion liquid;
aggregating dispersed particles in the oil-in-water dispersion liquid; and
after the aggregating, adding a polyester water dispersion containing the amorphous polyester resin A to the oil-in-water dispersion liquid to aggregate the amorphous polyester resin A in the polyester water dispersion.

7. Toner resin particles comprising the resin particles according to claim 5.

8. A toner comprising the toner resin particles according to claim 7.

9. A developer comprising the toner according to claim 8.

10. A toner storage unit storing the toner according to claim 8.

11. An image forming apparatus, comprising:
an electrostatic latent image bearer;
an electrostatic latent image forming device to form an electrostatic latent image on the electrostatic latent image bearer; and
a developing device including the toner according to claim 8, to develop the electrostatic latent image formed on the electrostatic latent image bearer with the toner to form a visible image.
